(19) United States
(12) Patent Application Publication
(10) Pub. No.: US 2020/0111044 A1
(43) Pub. Date: Apr. 9, 2020

(54) WorkMerk Flowchart

(71) Applicant: WORKMERK, LLC, Conshokocken, PA (US)

(72) Inventors: John R. New, JR., Berwyn, PA (US); Patrick J. Murphy, Bristol, PA (US); Steven L. Parker, Arlington, VA (US); Joseph L. Narke, Plymouth Meeting, PA (US); Robert J. Cirino, Newark, DE (US)

(21) Appl. No.: 16/595,294

(22) Filed: Oct. 7, 2019

Related U.S. Application Data
(60) Provisional application No. 62/741,567, filed on Oct. 5, 2018.
(60) Provisional application No. 62/741,569, filed on Oct. 5, 2018.
(60) Provisional application No. 62/741,571, filed on Oct. 5, 2018.
(60) Provisional application No. 62/741,574, filed on Oct. 5, 2018.
(60) Provisional application No. 62/741,575, filed on Oct. 5, 2018.
(60) Provisional application No. 62/741,576, filed on Oct. 5, 2018.
(60) Provisional application No. 62/741,579, filed on Oct. 5, 2018.
(60) Provisional application No. 62/741,580, filed on Oct. 5, 2018.
(60) Provisional application No. 62/741,582, filed on Oct. 5, 2018.
(60) Provisional application No. 62/741,584, filed on Oct. 5, 2018.
(60) Provisional application No. 62/741,587, filed on Oct. 5, 2018.
(60) Provisional application No. 62/741,623, filed on Oct. 5, 2018.
(60) Provisional application No. 62/741,656, filed on Oct. 5, 2018.
(60) Provisional application No. 62/741,976, filed on Oct. 5, 2018.
(60) Provisional application No. 62/741,632, filed on Oct. 5, 2018.
(60) Provisional application No. 62/741,679, filed on Oct. 5, 2018.
(60) Provisional application No. 62/741,698, filed on Oct. 5, 2018.
(60) Provisional application No. 62/741,876, filed on Oct. 5, 2018.

(51) Int. Cl. G06Q 10/06; G06F 16/23; G06F 16/25; G06F 16/22; G06N 3/08; G09B 7/00

(52) U.S. Cl. CPC G06Q 10/063112; G06F 16/2379; G09B 7/00; G06F 16/2291; G06N 3/08; G06F 16/252

(57) ABSTRACT

A system comprising at least one database and a machine learning computing system to generate optimized learning modules with a track cycle; wherein a track cycle comprises at least one nano learning module, at least one micro learning module, and at least one macro learning module; wherein a track cycle further comprises at least one assessment corresponding to the at least one nano learning module, the at least one micro learning module, or the at least one macro learning module; wherein upon the completion of an assessment, said database is updated to confirm that a learning module, made up of the combination of the at least one nano learning module, at least one micro learning module, and the at least one macro learning module is completed; wherein the machine learning computing system identifies an optimized next track cycle to optimize the next learning module; wherein the machine learning comprises collecting data from at least one user comprising the user's skills and data, and generating optimized outputs for the user based upon expected returns based upon taking further actions as determined by an optimized output; and wherein in certain elements, a robot embodies the machine learning computer and is able to gather data in real-time to further optimize the optimized output.

### PRIORITY CLAIM

This application claims the benefit of U.S. Provisional Application No. 62/741,567; U.S. Provisional Application No. 62/741,569; U.S. Provisional Application No. 62/741,571; U.S. Provisional Application No. 62/741,574; U.S. Provisional Application No. 62/741,575; U.S. Provisional Application No. 62/741,576; U.S. Provisional Application No. 62/741,579; U.S. Provisional Application No. 62/741,580; U.S. Provisional Application No. 62/741,582; U.S. Provisional Application No. 62/741,584; U.S. Provisional Application No. 62/741,587; U.S. Provisional Application No. 62/741,623; U.S. Provisional Application No. 62/741,656; U.S. Provisional Application No. 62/741,976; U.S. Provisional Application No. 62/741,632; U.S. Provisional Application No. 62/741,679; U.S. Provisional Application No. 62/741,698, and U.S. Provisional Application No. 62/741,876, each of which was filed Oct. 5, 2018, and each of which are incorporated herein by reference in their entirety.

### FIELD OF INVENTION

The present invention is generally related to devices, systems, and methods of use of certain computer-based algorithms that can be utilized through database systems. In certain embodiments, the algorithms and database systems further comprise robotics and programmed robots for providing educational services as well as generating new in-person and online teaching strategies to maximize training, education, and sales and marketing strategies.

In preferred embodiments, AI (also called “IVI”) is a trained neural network within the cloud and can precipitate into any device. In certain applications, AI can be facilitated within a robot defining a plurality of sensors. IVI therefore functions as a neural network having a database and a graphical user interphase that is defined through computer readable and executable software to optimize and generate optimized results with the purpose is to be an articulation point between a database and a human wanting to leverage and use the database for making decisions.

In sum, the embodiments rely upon certain hardware devices and optionally combined with machine learning (AI) to provide for unique methods and systems for generating efficiencies in the workplace.

### BACKGROUND OF INVENTION

Productivity of workers in a corporate environment is a key metric that contributes towards profitability. In the simplest terms, hiring productive workers, those who produce greater value than less productive workers, drives value to the company. For example, in a sales organization, workers who generate more sales are more valuable than workers that generate fewer sales. While this seems obvious, the ability to actively quantify such metrics is not always readily available, nor are there tools available to assist individuals in educating and training workers to maximize productivity.

Training the workforce is a difficult task, as workforce size can be enormous and generating content to target each individual within the workforce and ensure competency is difficult. Current protocols often utilize only traditional educational models including books, pamphlets and classroom-like settings to seek to educate the workforce. However, studies conclude that many portions of the workforce remain under trained and lack the competencies that would allow them to be better employees.

It is not just raw ability that leads to successful workforces, but also the ability to work well with others is a trait that is extremely powerful. While some individuals possess the ability to give and take with others, regardless of the personality of the other person, other individuals face a more difficult task in finding compromise and benefiting from partnership. However, far too often, we pair persons with improper traits and detract from the common goal. Thus, there is ample opportunity to find ways to solve this known problem.

Herein, we describe the ability to optimize the workplace through optimization strategies. Furthermore, we identify new systems, methods, and protocols comprising use of electronic devices to provide reminders to users in order to more efficiently learn and perform learned skills. In some further embodiments, the systems and methods utilize devices comprising sensors, wherein a robot device can utilize AI to assist in developing educational tools and for preparing and developing coursework in live and recorded materials. Furthermore, the robot can be tailored to utilize sensory tools to evaluate individual experiences and to tailor these with the educational opportunity. These same tools can be utilized for sales and marketing applications as well.

### SUMMARY OF INVENTION

The embodiments of the present disclosure detail a new and useful methods, systems, and other protocols for optimizing learning strategies. Preferred embodiments utilize mobile applications, optionally together with a wearable device, wherein the embodiments provide for strategies, systems, and methods for retaining of data, reinforcing learning, ensuring accuracy of a protocol (such as standard operating procedure “SOP”), and tracking and optimizing the same through reinforcement.

In preferred embodiments, a method comprising increasing retention of data comprising: identifying the data to be retained and providing said data to a user; and providing a reinforcement to said user of said data at a subsequent time, through a pushed learning opportunity. For example, the data is a new software system, where a training is provided to teach said data (i.e. how to use the software system). Using a mobile platform and/or a wearable tech (a watch, for example), reminders are provided to the user to perform or use the data as instructed. This allows for much greater retention of the learned data, thus improving performance. Such reminders may be a nano learning session (e.g. a text (a nudge) or quick overview; a micro session (a longer reminder, though can be a text or nudge), where said reminders can be provided based on a number of different occurrences including but not limited to location, time, or another condition precedent.

In certain embodiments, a reminder is provided when an event occurs (a condition precedent) that is traceable. E.g. a particular time of day, a particular location, an action by the user, each of which actions can be tracked and identified in a database and the reminder pushed to the user to improve the data retention or to correct it in some cases.

In a preferred embodiment, a method of increasing retention of data comprising: identifying the data to be retained by a user; providing the data to the user; providing a reinforcement action to said user in the form of a notification on an electronic device; and wherein providing said reinforcement action to said user increases retention of the data.

In a further preferred embodiment, the method wherein the data is selected from the group consisting of a standard operating procedure (SOP); a task to complete; instructions; or facts.

In a further preferred embodiment, the method comprising at least a second reinforcement action; wherein said second reinforcement is different than the original reinforcement action.

In a further preferred embodiment, the method wherein the data is stored electronically within a server; and wherein the reinforcement action is stored within said server.

In a further preferred embodiment, the method wherein the reinforcement action is provided upon the occurrence of a traceable event.

In a further preferred embodiment, the method wherein the occurrence the traceable event is defined within a database.

In a further preferred embodiment, the method wherein the reinforcement is provided upon the electronic device being placed within a predetermined proximity to a location.

In a further preferred embodiment, the method wherein the location is defined by the group consisting of a geofence, a WiFi signal, an RFID signal, a wireless signal, a radio signal, or a beacon.

In a further preferred embodiment, the method wherein the reinforcement is provided at a predetermined time.

In a further preferred embodiment, the method wherein the data to be retained is defined within an SOP, wherein an error in the SOP is defined as a traceable event, and wherein the reinforcement is provided upon the occurrence of the error in the SOP.

In a further preferred embodiment, the method wherein the error in the SOP is remedied after receiving the reinforcement.

In a further embodiment, a system for increasing retention of data comprising a database and at least one electronic device capable of sending and receiving wireless notifications of information from said database, wherein a data point to be retained by a user is loaded onto said server; a notification is pushed to said user and received on said electronic device, said notificaiton comprising material to reinforce the data.

In a further preferred embodiment, the system wherein said electronic device is selected from the group consisting of a smartphone or a wearable electronic device.

In a further preferred embodiment, the system wherein said electronic device comprises a mechanism to determine location; wherein the database provides for said notification to be pushed to said user upon entry to a particular location; and wherein said notification is pushed to said electronic device upon entry to said location.

In a further preferred embodiment, the system wherein said electronic device and database comprises a time keeping mechanism, and wherein upon the occurrence of a predetermined time, a notification is pushed from said database to said electronic device.

In a further embodiment, a system for creating time and location based records comprising: a database, an electronic device, said electronic comprising a software application having a graphical user interphase for sending and receiving data from said database; said electronic device comprising a timing mechanism and a location defining mechanism; said graphical user interface defining at least one task to be completed; said task having a binary feature for annotating the completion of said task, said binary feature capable of being annotated only upon meeting either a predetermined location or a predetermined time, wherein upon meeting said predetermined location or said predetermined time, said binary feature is authorized to allow annotation of the task.

In a further preferred embodiment, the system wherein said graphical user interphase displays the requirements to allow the binary feature to be authorized.

In a further preferred embodiment, the system wherein both the time and location must be simultaneously met to allow the binary feature to be authorized.

In a further preferred embodiment, the system wherein upon the annotation of the task, the time and location of said annotation is recorded within said database.

In a further preferred embodiment, the system wherein the task to be completed is displayed only upon meeting either the time or location criteria, wherein the task to be displayed is provided as a notification onto said electronic device.

In a further embodiment, a method of increasing the retention of a learned skill comprising: teaching a skill to a user; providing a digital device to said user, said digital device capable of receiving messages; said digital device having criteria defining a requirement to send said message; sending said message upon receipt of criteria.

In a further preferred embodiment, the method wherein the criteria are location-based.

In a further preferred embodiment, the method wherein the criteria are time-based.

In a further preferred embodiment, the method wherein the digital device is a handheld device.

In a further preferred embodiment, the method wherein the digital device is a wearable device.

In a further preferred embodiment, the method wherein the message comprises learning materials.

In a further preferred embodiment, the method wherein the learning materials comprise a video, a checklist, a task, or an SOP.

In preferred embodiments, the system comprises at least one database and a machine learning computing system to generate optimized learning modules with a track cycle; wherein a track cycle comprises at least one nano learning module, at least one micro learning module, and at least one macro learning module; wherein a track cycle further comprises at least one assessment corresponding to the at least one nano learning module, the at least one micro learning module, or the at least one macro learning module; wherein upon the completion of an assessment, said database is updated to confirm that a learning module, made up of the combination of the at least one nano learning module, at least one micro learning module, and the at least one macro learning module is completed; wherein the machine learning computing system identifies an optimized next track cycle to optimize the next learning module.

In preferred embodiments, there are a plurality of nano and micro learning modules. In preferred embodiments, the macro learning module is performed in-person. In preferred embodiments, the nano learning modules are less than one-minute in length. In preferred embodiments, the micro learning modules are less than five-minutes in length.

A method of optimizing learning for an individual comprising: uploading a set of known information to a database; uploading a set of information to be learned to said same database; generating a track cycle comprising a first learning module, said track cycle comprising at least one nano learning module, at least one micro learning module, and at least one macro learning module; wherein upon completion of the at least one nano, micro, and macro learning modules, completing at least one assessment; updating the database, upon satisfactory completion of the assessment, with the first learning module from to be learned to known information. In a preferred embodiment, the method further comprising utilizing a machine learning computing system to identify the next learning module within a subsequent track cycle to be completed to optimize learning efficiency.

In certain embodiments, the method comprises wherein the set of information to be learned comprises a ranking of importance of information, wherein more important information ranking can be utilized to determine optimized learning efficiency.

In certain embodiments, optimized learning efficiency is determined by a corporate structure. In certain embodiments, a track cycle comprises a plurality of individual users, wherein the optimized learning module is dependent on the greatest gains for the entire team and not individually.

An optimized learning method for learning information in an optimized manner comprising at least one nano, at least one micro, and at least one macro learning module, wherein a subsequent nano, micro, or macro session is determined based upon an assessment of the prior session. The method, wherein an assessment being completed is updated into a database from an unknown skill to a known skill, and new information is presented comprising a second at least one nano, micro, and macro learning module.

In a preferred embodiment of the present disclosure detail a robot comprising: (1) memory to store instructions; (2) a plurality of database entries for determining optimization of a task; as well as (3) sensors, capable of sensing parameters within a defined space; wherein the parameters sensed can be evaluated by machine learning to identify facial recognition, etc. Wherein the sensors can utilize the database entries and information generally to determine and optimize learning and presentations towards at least one person.

In a preferred embodiment, a robotic element performs the following elements: 1. Communicates with people; 2. Uses sensors to read facial expression, voice tone, review eye contact; 3. Communicates with people it is analyzing—use of sensor information, IVI (AI) can then analyze information and make decisions based on input received; and 4. Targeted education based on analysis—or targeted sales based on analysis.

In a preferred embodiment, a method of improving education comprising determining an educational track comprising a plurality of nano and micro learning sessions; capturing assessment data through a sensor; determine an optimized educational track based upon the nano and micro learning sessions and the assessment based on data from said sensor. In certain embodiments, the sensor is positioned on a robot. In certain embodiments, the sensor is a camera or a microphone.

A method of improving sales opportunities comprising: performing a sales pitch; capturing data on one or more sensors, said sensors capturing sound or visual data; communicating with a user performing a sales pitch, wherein said communication corresponds to sound or visual data captured from said one or more sensors.

In a preferred embodiment, a method of capturing data from at least one sensor, as described herein, transmitting said data to a database; mining said database against an input; verifying the occurrence of an event tied to either the input or the data; rewarding actions form the verified occurrences. In certain embodiments, the data is visual data. In certain embodiments, the data is a written assessment. In certain embodiments, the database comprises a plurality of user entries, each entry comprising a set of data regarding skills, education, personality, and location. In certain embodiments, the verification step comprises verification through blockchain. In certain embodiments, the reward is provided in a badge. In certain embodiments the reward is provided in cryptocurrency.

In certain embodiments, the method comprising AI. In preferred embodiments, the AI is machine trained through a data set comprising the plurality of user entries within the database. For example, the database comprises 500 different user profiles and the task is to match users whom work well together. The database can define all interactions where users worked well, and where users did not work well, as defined by a metric; and then use machine learning to train the AI to pair users based upon that training, corresponding to the skills, education, personality, and location as data points.

In a preferred embodiment a method of engaging healthcare wellness comprising: a wearable device; a database with healthcare requirements; capturing data from said wearable device and comparing said data to a predetermined optimal data for a user; providing a notification to said user if a data point is out of line; providing instructions to rectify the out of line data point; confirming when the data point is in line.

In a preferred embodiment, the data comprising biometric data. In a preferred embodiment, the data comprising confirmation of medication consumption. In a preferred embodiment, a medication consumption can be tied to a pill dispenser that can be actuated and recorded within the database to confirm that the medication is dispensed. In a preferred embodiment, a user must confirm that medication was consumed. In a preferred embodiment, the wearable device receives confirmation or provides a reminder or both to a user to take medication or confirm the consumption of medication.

In a further embodiment, a method of manufacturing culture comprising: generating a cultural goal for a company; uploading a plurality of mosaics to a database, corresponding to the mosaics of employees at the company; determining an optimized track cycle to generate a cultural response in the employees based upon the totality of mosaics; beginning a track cycle among at least a portion of employees at a company; completing said track cycle; performing an analysis of the next optimized track cycle to develop culture.

In certain embodiments, the cultural change may be more travel, more exercise, reduced smoking, healthier food consumption, healthier beverage consumption, greater team dynamics, greater sharing among team members, greater performance, as non-limiting examples, or combinations thereof. In a preferred embodiment, gamification is provided to incentivize a cultural change among individuals or teams within a company. In a preferred embodiment, a cultural change is increased health and wellbeing comprising improved food consumption, healthier beverage consumption, and more exercise; wherein a wearable device is utilized to track and reward points for certain actions; wherein an action of exercise is worth a point, an action of water is worth a point, an action of a salad is worth a point; and certain negative actions are worth −1 point, such as smoking, alcohol consumption, or soda consumption; wherein gamification provides for an incentive once reached at an individual or team wide level. In a preferred embodiment, wherein teams of employees compete against another group of employees. In a preferred embodiment, a check-in station allows for capture of points at a water station, or a gym, and wherein points from a food provider are electronically scored. In a preferred embodiment, a check-in station is provided for entrance and exit to a smoking area for negative points.

In a preferred embodiment, a method comprising any one of the features above, further comprising a point of sale (POS) system. In a preferred embodiment, the POS system connects to capture a sale generated through any of the embodiments described herein.

### BRIEF DESCRIPTION OF THE DRAWINGS

FIG. 1 depicts a flowchart of a Track Cycle and the interaction of components within a system.

FIG. 2 depicts a flowchart of a hardware device and the communication with various components of a system.

FIG. 3 depicts a flowchart detailing a location-based task method.

FIG. 4 is an example of a Track Cycle for learning someone's name.

FIG. 5A is a detail of a flowchart of a Track Cycle.

FIG. 5B depicts the Track Cycle as applied to a group setting.

FIG. 6 depicts a flowchart showing selection of content based on questions and answers within a track cycle.

FIG. 7 depicts a flowchart of modifying content based on assessments of an individual.

FIG. 8 depicts a flowchart depicting deployment of nano learning sessions based on data.

FIG. 9 depicts a scanning process for collecting data and booking a space.

FIG. 10 depicts how IVI can call together a team for an impromptu meeting at any given moment.

FIG. 11 is a map of the many different ways IVI may manifest itself to users.

FIG. 12 depicts a flowchart of how IVI is a personal and professional growth guide.

FIG. 13 depicts how IVI is an engagement steward for healthcare.

FIG. 14 is a flowchart of how IVI, perhaps as a robot, can use computer vision and interaction to acquire information for an individual's mosaic.

FIG. 15 is a flowchart of how IVI can assist facilitators of in-person learning.

FIG. 16 depicts a flowchart of booking a space and generating custom solutions for branding a space.

FIG. 17 depicts a flowchart of booking meetings, for example with an in-person meeting with a speaker.

FIG. 18 depicts a flowchart of how IVI may be used as a source of entertainment when there is a lull in a meeting.

FIG. 19 depicts a flowchart where IVI recommends how to position content in a business meeting presentation for optimal intake from the audience.

FIG. 20 depicts a flowchart of how IVI can assist a team manager to make hiring decisions.

FIG. 21A depicts a flowchart where IVI optimizes the physical set-up of a workspace.

FIG. 21B depicts a flowchart of how IVI can identify when guests come and how they move throughout the space.

FIG. 22 shows an example of IVI acting as a personal virtual assistant to users.

FIG. 23 depicts a flowchart where IVI identifies a customer, their preferences, and synchronizes that customer's experience with the wearable technology of the staff support that experience.

FIG. 24 depicts a flowchart of how IVI can be a compliance assistant.

FIGS. 25A and 25B depict a flowchart of optimization strategies within a workplace.

FIG. 26 depicts a flowchart of inputs and AI to optimize workflow with regard to a customer.

FIG. 27 depicts a flowchart detailing an embodiment of optimizing and incentivizing healthcare engagement within a workplace.

FIG. 28 depicts a flowchart detailing an embodiment to manufacture of culture within a workplace.

FIG. 29 depicts a flowchart of integration with POS within a company.

FIG. 30 depicts specifics of reward systems/gamification.

FIG. 31 depicts detail of triggers for reward systems.

FIG. 32 shows a flowchart depicting how a simulation can replicate real-world situations in practice situations.

FIG. 33 details an example of a check-in station or wearable device interface.

FIG. 34 depicts details on the flowchart of movement and flow of data.

FIG. 35 depicts a flowchart of how a crew call request triggers many devices and how those devices can be used to respond in various ways.

FIG. 36 depicts how crew call can help a customer receive support quickly from a staff member.

FIG. 37 depicts a flowchart of AI process to identify best fit based on compatibility scores.

FIG. 38 depicts a best fit and educational track between two or more users to improve compatibility score in real-time.

FIG. 39 depicts a flowchart of the various systems as combined together.

FIGS. 40A and 40B depict a flowchart of the function of a one-way nudge.

FIGS. 41A and 41B depict a flowchart of the function of a two-way poll nudge.

### DETAILED DESCRIPTION OF THE EMBODIMENTS

The embodiments as described herein can function alone, or in combination with one or more of the entire whole, or a component of another embodiment. It is envisioned by the inventors that the specific elements may be utilized in such manners that would take both whole and partial elements of one or more applications and combine them with whole or partial elements of other applications. In sum, the embodiments can function as a complete system, allowing for seamless collection of data, projection of material, and therein identify and generate efficiencies in the workplace, or in their individual capacity.

Service businesses succeed when they provide a service to customers better than another business. Thus, success is based on identifying a need and then performing that for the customer with excellence. Often times, excellence is engaging with learned skills, those taught by the managers and other employees. Whether this is a way to learn a customer's name, how to read body language, making eye contact, getting an order correct, providing services faster, or cheaper, or better. All of these come through providing excellence.

Many times, once excellence is determined, a business creates protocols, or standard operating procedures (“SOP”), which are then used to both reinforce the positive steps and habits of those most successful, and also to train those who are new or can learn to be more successful. Thus, as detailed in the embodiments herein, methods and systems are defined in which some data is learned (data being used generally to define an element learned or to be learned), wherein a user is provided with the data, such as being given an SOP, a training course, a flyer, a manual, etc. Then, in the embodiments, the user is provided with reminders to a mobile device, such as a phone or a watch (the watch can be a mobile device, but is also a wearable device), which provides small reminders of the data. In certain embodiments, these small reminders are called nano or micro learning, and in other embodiments, these small reminders are called “nudges.” By providing learning reminders, the data provided is learned and retained at much higher levels than without such reminders.

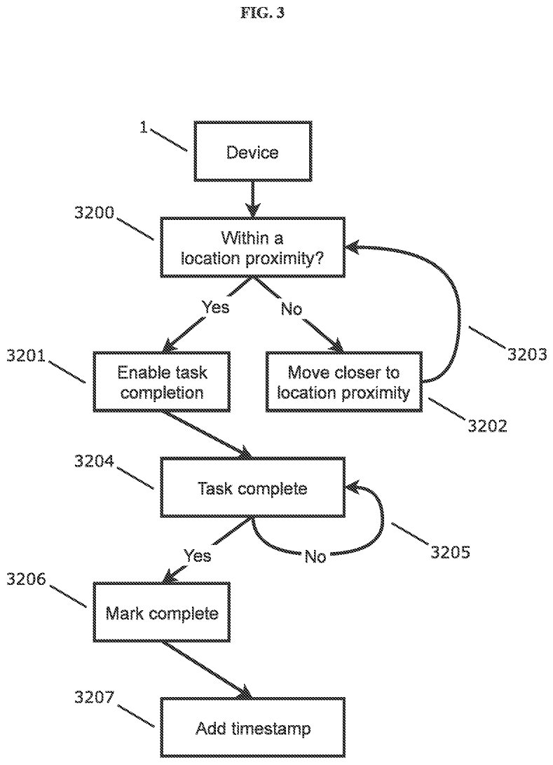

In the various embodiments, several different applications for this are provided, as well as times and opportunities to provide the reminders. For example, as in FIG. 3 and others, a reminder may be provided based on location, e.g. a longitude/latitude, based on a geofence, based on a beacon, an RFID, Bluetooth, WiFi, or other proximity sensing device. Thus, a user might “check-in” by being in proximity to said location, which enables a reminder or enables other functionality for the user.

In other embodiments, the reminder is generated at a given time, e.g. before a user would start a task at a predetermined time each day. Other times, where a user provides data entry or actions that can be tracked in a database, where errors or inaccurate elements occur, the database can use AI, (as defined herein, e.g. IVI), to identify the error and provide an appropriate learning module to remedy the error, prevent the error in the future, or to simply re-teach or re-train the user.

In other embodiments, the learning is provided at a predetermined time, a random time, or at the behest of a manager or other employee. Thus, learning, retention of learned data, and reminders provided from the same become a powerful tool, which is explained in the numerous embodiments herein. In certain embodiments, further details are provided which utilize AI to engage with a variety of data points to further enable and enhance learning, for example through a track cycle.

Track cycle, as used herein, refers to the cyclical learning, assessment, and strategic planning for more learning. In essence, once a skill is learned and assessments define success with learning of that skill, the ultimate question revolves around what to learn next, so as to optimize the benefit to a user, to a team, or to a company as whole. The assessment can be performing that task, doing a task on time, within a pre-determined time, at a particular location, etc. Such assessments are obviously able to be tracked by both the user and by the provider of the device. Indeed, the next track, or next skill to learn may vary widely depending on whether the ultimate goal is to benefit the individual or the company as a whole. For example, an individual might want to get as much training as possible on all software systems used by the company, as this would increase the individual's productivity and efficiency at the office and allow for a faster promotion. While the company also wants that gained efficiency, the company has a greater focus on health, wellbeing, and safety, and thus modules that identify proper safety protocols, mindfulness, healthy habits, etc., ultimately provide a stronger return within the company as a whole. In other cases, for example, insurance premiums are due for the company, and a module about the first safety issues is run, so that all employees know the fire exits and how to use a fire extinguisher, and this nets the company a reduction in premium. That may be ultimately unused by the individual, but is valuable, financially, to the company as a whole. These factors can be utilized to determine and create value for learning module efficiency.

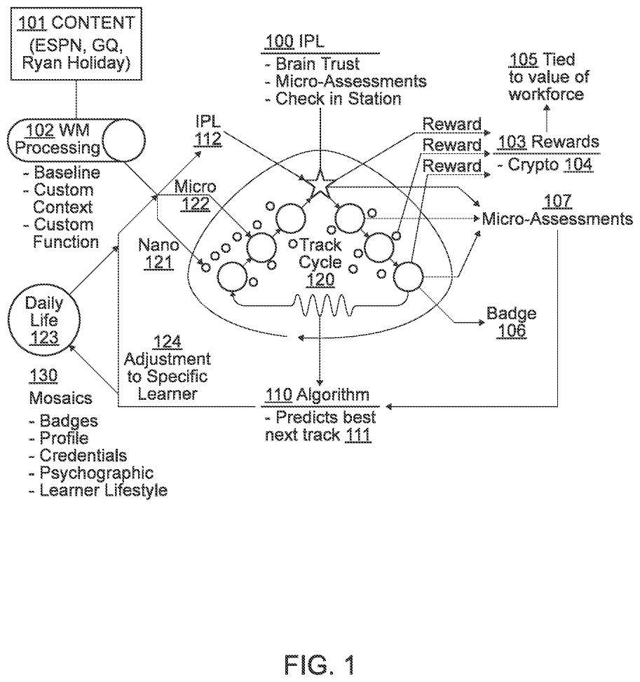

Accordingly, as defined in FIG. 1, the Track Cycle 120 is a cycle of different learning sessions, for example the nano 121 and micro 122 learning sessions on the left arm of the track cycle 120 triangle, a top vertex that refers to an In Person Learning (IPL) session 100, and the right arm of the triangle including assessments and confirmation aspects of whether the information was actually learned by the user. Each of these elements may exist alone within a learning module for learning of particular data, or in combination with each of the features together.

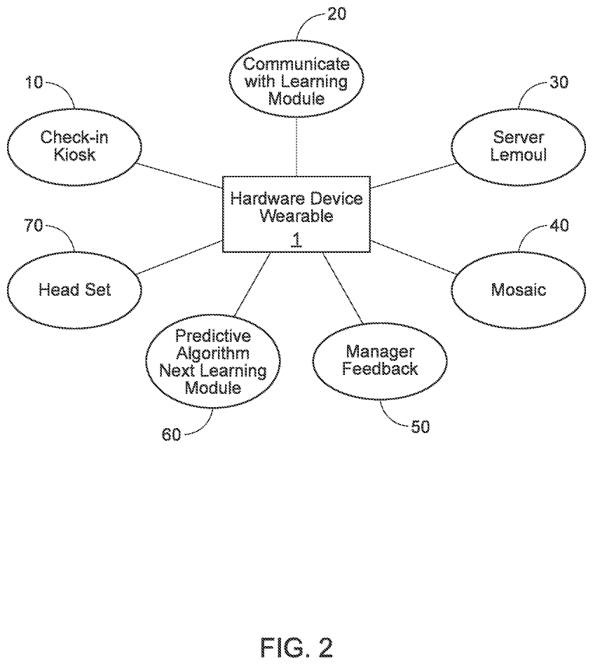

In preferred embodiments, delivery of one or more of the components within the track cycle 120 is through technology enabled devices. For example, certain components are best delivered through a wearable device 1 as detailed in FIG. 2, e.g. glasses, a watch, a ring, an earbud, while others are best delivered through a tablet, a phone, a computer; and yet other components are best delivered in person. The track cycle 120 preferably uses one or more of these different components to deliver educational materials, namely a reminder such as a nudge, to enable greater comprehension and ultimately retention of the data to be learned.

With particular focus on FIG. 1, a component of the track cycle 120 is a triangle, the base, being an oscillating line 110 which represents an algorithm (or AI), which is used for determining the next best fit for a cycle. One arm of the triangle comprises a series of reminders formed as learning sessions, e.g. nano 121 and micro 122 learning sessions, while the right-hand arm finishing the triangle, comprising at least one assessment or a series of assessments, and outputs from the learning sessions. For example, the assessment being performing on the job, or performing under specific guidelines, so that the assessment can be tracked and scored, and execution or learning of the data can be confirmed, and if not learned, it can then be reinforced. In certain embodiments, a wearable device 1 allows for the track cycle 120 to be activated on the device itself (e.g. through an application comprising a GUI for displaying said information) and to receive content on the wearable device 1, for example the nano 121 or micro 122 learning sessions may be delivered via the wearable device 1, or to perform assessments on the same device 1.

The track cycle 120 functions as a data point or data set to be learned, followed by a collection of learning sessions that combine together to reach a certain educational goal. In certain embodiments, the nano 121 or micro 122 sessions are repetitive, so as to ingrain a particular issue, while in other cases, the nano 121 and micro 122 sessions teach small components of a larger whole, to slowly and steadily teach the particular educational goal. In other cases, the learning sessions are daily or hourly reminders, or reminders provided based on location, proximity to a particular situation and the like. For example, a track cycle 120 has a goal of teaching how to cut tomatoes. A nano 121 session might show how to hold the knife, another session about how to hold the tomato to safely cut, a third session about pressure on the knife to cut the tomato, a fourth session about slicing or sawing on the tomato to make the cut, etc. A micro 122 session might review the first and second nano 121 modules, then the 2nd and 3rd, then the 3rd and 4th, etc. Furthermore, the reminders, presented as nano or micro learning sessions may present the material to teach these aspects one way, for example visually, and then teach it again using a different learning style.

A reason for this split learning strategy is that in many cases, users are overwhelmed by data and information and do not, therefore, actually master the material be presented. For example, imagine a typical scenario at a large working environment with dozens of books and information about how to use software or machines at a workplace. Skimming each book might generate a modicum of learning of each subject, but typically will not generate mastery of the material. By contrast, learning that is targeted at mastery of a specific skill can narrowly focus the individual on that skill and, after a few learning sessions, achieve mastery. For example, learning a new data entry software can be learned with several short sessions, over the course of a day, a week, a month, or longer. Focus on an individual skill instead of multiple skills ensures mastery of the individual skill. After mastery is achieved, even in a narrow sense, we can move forward to a new topic or skill. In preferred embodiments, a particular cycle can be as few as at least one nano, at least one micro, and then at least one assessment. In certain embodiments, the cycle can further comprise at least one macro session, such as an in-person session. Preferably, a track cycle includes several nano and micro learning modules and corresponding assessments.

Accordingly, to drive this track cycle 120, learning sessions include nano learning 121, micro learning 122 and, optionally, macro/in person learning sessions 100. Beginning at the bottom left corner a nano learning session 121 is identified. For example, an individual is learning a spreadsheet software system and a typical plan would be a course for an hour or more to learn certain aspects of the software system. Data and teaching may be first provided, and then to cement the learning or instead of a first learning sessions, a plurality of nano learning sessions 121 are generated for the user over the course of a day, a week, several weeks, a month, or longer, and each nano 121 learning session builds upon or provides a reminder toward creating core competency for the individual skill being learned. A nano learning session 121 typically includes a training session of less than one-minute. Thus, in the spreadsheet software example, a first session might teach how to enter data into a box, a second might show how to create formulae, a third might teach how to combine the box with a formula, a fourth might teach modification of data in a box or formula, etc. Each session can be repeated, as necessary, but these give small, discrete learning modules. By using discrete learning modules, individual users are more likely to remember the specific element taught, as compared to trying to teach several specific elements in a single session. These learning modules may, of course, be based upon the pre-determined Standard Operating Procedure (“SOP”) or plan developed by the company.

In certain preferred embodiments the reminder and learning can be specifically tailored to the individual, whether it be based on the data (e.g. SOP, or task) to be completed, or based on the individual's required skill training. For example, the nano learning sessions 121 are generated via content 101 that is modified for the individual user through WM processing 102, i.e. a machine learning or optimizing algorithm that can generate content to the users within the track cycle. The content is focused to the individual, or to a team, or to a company based upon several factors, which can be tailored as necessary for each individual, team, or company. For example, individual tailoring would take learning styles (as identified by data within a mosaic 130), and generate content based upon the individual's learning style. Some learn via pictorial, some learn via spoken words, some through written prose, and others through combinations of these. Thus, an individually tailored approach would take the skills and learning style of the individual and generate through the WM processing 102 a tailored lesson for the individual's learning style.

In certain preferred embodiments, a complete set of learning modules includes not only the at least one nano learning sessions 121, but these at least one nano sessions 121 are also combined with additional learning sessions, including the micro learning session 122, which may continue daily, hourly, or upon location based services, as necessary to ensure performance. As compared to nano sessions 121, micro learning sessions 122 are typically one to five minutes in length, but typically expand the scope and duration of the learning session. Where the nano learning 121 is typically delivered on a wearable device 1, the micro learning 122, being somewhat larger and longer in stature, may also be delivered on a mobile computing device, (laptop, phone, tablet, etc.). Both the nano learning 121 and the micro learning 122 may show both types of content and also allow for user input, for example the ability to respond or communicate with a device (for example one having a sensor, a location tracking, a time tracking, etc.) as necessary for enabling active learning of the skills. Accordingly, in concert with the learning sessions, assessment is being completed in certain instances, or assessments are simply provided on the job.

The micro learning session 122, like a nano 121, can both serve as a singular teaching point, but also to reinforce the data to be confirmed, from prior nano 121 or micro 122 sessions. For example, a track cycle 120 might include dozens of nano 121 sessions, but only a few micro sessions 122, and each micro session 122 might give a review of the salient points from earlier nano 121 sessions. Alternatively, the material may be wholly new, or simply build upon the foundational aspects from the nano 121 sessions. Alternatively, the sessions may repeat daily to confirm an SOP, or daily at a location. As with our prior example, if nano 121 sessions teach how to use a spreadsheet system, the micro learning 122 might then teach a more complex idea about how to use the spreadsheet system to perform some complex task, but one that requires mastery and knowledge of the underlying nano 121 sessions. Thus, the nano 121 sessions teach how to input data into the software, how to create a formula, how to apply the formula to many lines of data, etc. and then the micro session can wrap these concepts together to show how to plan extended profit and loss sheets, or expand out for projections, etc.

At some point during a track cycle 120, the material and educational sessions are grouped into a macro learning session, for example an in-person learning session 100. This session, typically 30-120 minutes (though longer or shorter duration is suitable in certain cases), uses a different type of learning, preferably that of person-to-person contact, and longer duration to both use the nano 121 and micro 122 learning sessions to build out new or more complex ideas, but also to reinforce those nano 121 and micro 122 sessions, and/or to give context to how they are utilized in the workplace. Indeed, this concept that learning is provided for reinforcement is important for both employees and employers, as it provides a backdrop for teaching data and then for confirming data mastery or confirming that the data is performed correctly each time.

In certain embodiments, it is not merely about data and reminders of the data, e.g. to perform an SOP correctly, but instead about true learning, wherein the end goal of the series of learning modules is to provide a number of different educational opportunities, delivered in different ways, to ensure that the core concept that is being taught in the track cycle 120 is being learned. We can then evaluate the efficacy of the learning sessions as a whole by different forms of assessments, e.g., micro assessments 107. In some cases, a single assessment 107 may be sufficient to confirm that the concept was mastered. In other applications, multiple assessments 107 are necessary to confirm the mastery of the detail and subtlety that may have been defined as the goal of the track cycle 120. Assessments are often best performed in real situations, namely, an employee has been trained and now must execute with customers or actual end products or responsibilities. We can track performance and provide updated reminders as often as necessary to ensure mastery of the data.

In certain embodiments, we can gamify the learning process. For example, in at least one embodiment, as assessments 107 are performed, data is collected from the assessments 107 and generates a reward 103 and badges 106 to confirm the mastery of the subject matter. For example, a track cycle 120 has a learning focus about cats, and an assessment 107 confirms through images, a sound of a cat, or other assessments 107 about particular features that were desired to be learned within the particular track cycle 120. Upon completion of the track cycle 120 and evidence of successful learning through successful responses on assessments 107, a badge 106 is awarded to confirm the completion and mastery of the subject and the badge 106 (badge being a database record of completion, which can be public or private) can be uploaded to the mosaic 130 of the user.

After the completion of the badging 106 process, the bottom of the track cycle triangle 120, the oscillating line indicates an algorithm 110 to determine the next track cycle 120 for completion. For example, the next best track cycle 120 is predicted 111 by reviewing the mosaic 130 (i.e. personalized database) of the individual or group undergoing a track cycle 120 and determining the optimal plan for learning through AI. Optimal can be defined at either or both of the individual level or the company level. Indeed, an individual can undergo multiple track cycles 120 at once, specifically one or more toward the individual and one more for the company. However, in certain embodiments, it is limited to a single individual and single company track, and in other embodiments, a single track, either individual or company is allowed, to confirm focus on the specific task to be learned. For example, the track cycle 120 for an individual would focus on core competencies necessary for the individual to be more productive at work. At the same time, the track cycle 120 for a group or cohort might focus on an issue that is critical to the company as a whole, even if some people in the group already have some knowledge or mastery of the subject.

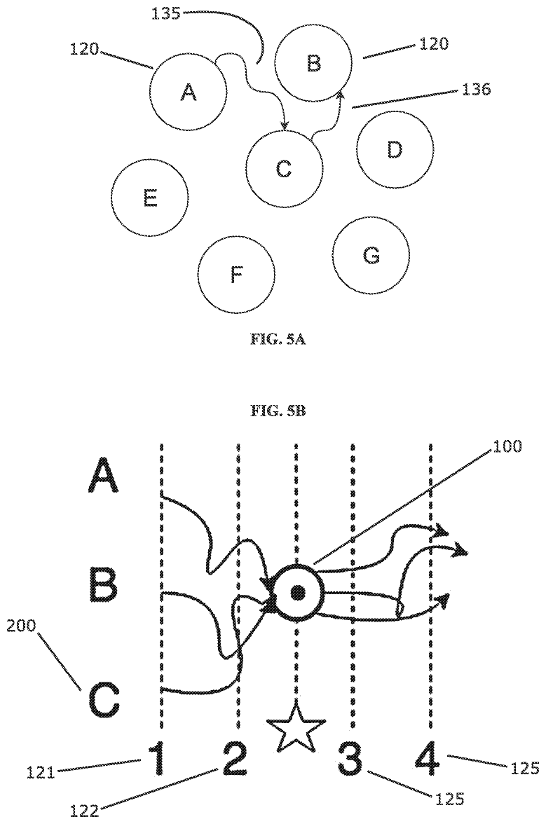

FIG. 5A details this concept, wherein features A, B, C, D, E, F, and G, are different track cycles 120. Beginning at track cycle A, there is a decision that must be made of the order to complete each of the cycles. An algorithm (AI) 110 is used to determine 135, 136 the next best track 111 for the individual or the group as whole. The decision is based upon several points, but primarily as to the company goals as a whole and, what will optimize the goal that the company is trying to reach. For example, the points might include: cultural improvements, technical improvements, safety improvements, health and welfare improvements, social improvements, and each company, and each individual can plan their personal growth and thus certain elements may be more important to others based upon the preferred end growth opportunity.

Accordingly, to make this decision, an algorithm 110 is utilized to capture data from one or more mosaic(s) 130 and then generate a recommendation and predict the next best track for the user 111. IVI (which can serve as the algorithm 110) can be used as software to take all the data from a mosaic 130 or from a group of mosaics 130, if related to a group decision, and define not just the track cycle 120, but the type of nano 121 and micro 122 learning sessions and the type (style) of materials given and generated to each individual to master the subject matter.

Indeed, FIG. 5B highlights this concept in a group setting. Three users 200: A, B, and C, are in a common track cycle 120. The track cycle 120 defines data regarding cats and each of user A, B, and C, who have different background knowledge about cats and each of A, B, and C, also have different learning styles. Accordingly, at the first learning session (Line 1), A, B, and C are at different points, namely, each user is receiving a different learning module. For example, while each user might be provided with the same material, the material may be displayed or provided to the user in a different form, and in other cases, the form is the same, but the material different.

At line 2, users B and C combine to receive the same materials for learning, while user A remains alone. The users then meet for a central in-person learning session 100, where each receives the same or similar message. Finally, paths 3 and 4 relate to different assessments 107 and different badges 106 rewarded based on the knowledge gained. Thus, the goal is that users can take different paths to still meet up at a single in-person learning 100. And despite each undergoing a similar track cycle 120 and the ultimate goal of all performing and mastering the subject matter, variance occurs and thus we have slightly different outcomes during the assessment 107 phase. Ultimately, the results are then utilized by the AI 110 to determine the next 111 track cycle 120 for the cohort.

At the same time, FIG. 5B can allow for different people to be on different tracks 120, namely A, B, and C, are each in a different track, but B and C still get the same material at line 2, and each of A, B, and C, have a common in-person learning 100 module, even though they are learning different track cycles 120. For example, the in-person learning revolves around eating pizza. User A learns about the components in a pizza. User B, who knows the pizza components, learns how to make dough. User C, who knows how to make dough, learns how to heat a pizza over. Together, A, B, and C, come together in an in-person learning session 100 and use their different tracks 120 to have a common in-person learning 100 that makes a pizza using the skills learned by A, B, and C. This then can generate teamwork and culture within the company, by uniting individuals together with different skills and fostering relationships that build upon the skills of each of the individual members.

After the IPL 100 is completed, the primary purpose of post-learning and assessments 107 is to cure out the information, i.e. through reinforcement. Of course, the primary assessment is simply performing the tasks in a working environment. In our pizza example, each of the different tracks would lead toward a common goal of the in-person learning of making a pizza, and then post IPL learning 125 would reinforce both the individual skills, but also those from the other members of the cohort, to ensure and reinforce the information and the shared experience and team building of the group as a whole. Thus, the post learning 125 and assessments 107 serve to reinforce the information based on the shared experience, i.e. we are also reinforcing the micro 122 and nano 121 learning as well as the IPL 100 experience. Accordingly, post learning is about moving from learning knowledge to doing or executing on the knowledge that is obtained in the track cycle 120.

The assessments 107, whenever and wherever they are collected, are updated into a mosaic 130 with materials that confirm the completion of the track cycle 120 and update on the materials learned, scores on assessments, and other information that can be collected from these modules and assessments. In this manner, there is accountability for both the employee and also for the employer to ensure that the material is learned, that reminders provide easy access for correct application during work (i.e. during the assessment). This information can be then utilized to prove that some action occurred, that the employee was not at fault for some issue, or that protocols were or were not followed. These concerns may be critically important when the actions of an employee or company as a whole need to be audited, or where proof is required of some issue occurring. In certain embodiments, there may be assessments that are in the post learning 125—so that you can then update the mosaic that shows that you have learned. Indeed, these may include on-job performance metrics, or other actual examinations or credentialing programs, as non-limiting examples of such assessments. In some embodiments, nano 121 and micro 122 learning sessions are utilized after the IPL 100. These learning sessions serve not as an exam, but as a reinforcement of the issues that are not mastered. For example, an assessment 107 reveals only partial mastery of a particular topic, and thus new nano 121 and micro 122 sessions, or repeats of prior sessions, can re-teach things that you lack for mastery of the subject. In other instances, reinforcement is something that is simply performed daily in order to increase accuracy and efficiency. In some embodiments, location or proximity data is generated and only then is a reminder (nudge) sent, and only within the location or proximity to a location can an element be executed that is necessary for record keeping. This provides strong contemporaneous data gathering that can be important to ensuring accuracy and completion. Accordingly, the assessment phase allows for capture of feedback regarding the quality and mastery of the material being taught. In some cases, absolute mastery may be necessary, and thus repeated teaching modules may be very important until mastery is achieved. Of course, in other cases, simple understanding of the existence of the issue being taught is sufficient for assessment purposes.

FIG. 3 is an example of using proximity and location-based elements to enable a reminder, which in this case is a task. Within an enabled device 1, the device uses location-based services to identify a particular location proximity 3200. Thus, the device can use a geofence, and determine whether the user is within that geofence or not. Another location-based service might be the use of a radio or WiFi communication to determine whether the device is proximate to a beacon or other element that confirms the location. If the device 1 is within the location proximity 3200, then a task on the wireless device 1 is enabled 3201. This means that a task is shown on the device and a user needing to mark that the task is complete 3204, will only be able to make that election if the location proximity 3200 is confirmed. If the device is not within the location proximity, then in order to enable the task completion 3201, the user will have to move closer to the location proximity 3202 and the system will retry 3203 the location proximity. In this manner, a task can be marked complete 3206 only when in the proximity to the location 3200. If the task is not yet complete 3205, the task can be finished and then, assuming that the device 1 is still within the location proximity 3200, the task can be marked complete 3206.

In preferred embodiments, once the task is marked complete 3206, a database entry is secured and a timestamp 3207 can be advantageously added to the database entry, which provides for completion of the task, a location and a timestamp for said task completion.

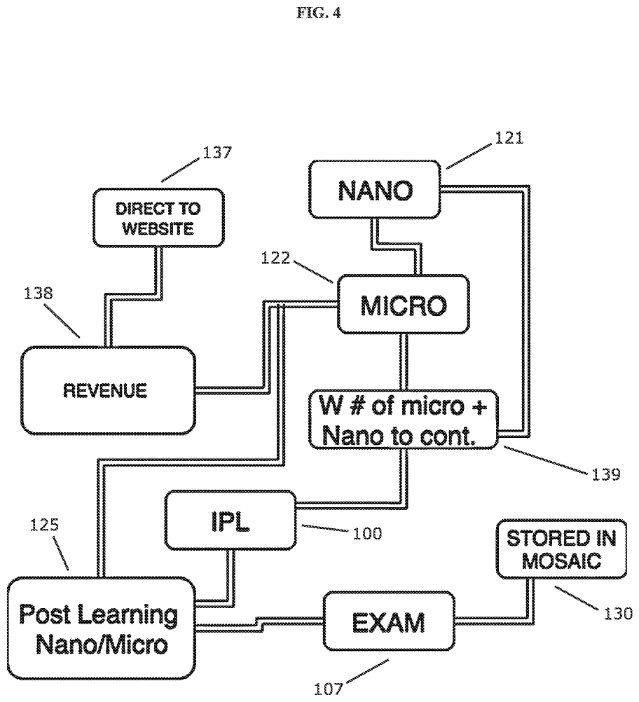

A further example is provided by FIG. 4, which details a Track Cycle 120 for learning someone's name. A nano learning session 121 is deployed and a user is sent a photo and name of person X. A micro learning session 122 is deployed to give the user information on person X and more photos of what they like to do. These are when commitments are made. For example, IVI (algorithm) knows that you like to bike so a nano/micro learning module 139 could be that it tells you to connect with person X who also likes to bike. The micro learning module guides you to make a commitment to do this with person X. Thus, these real examples provide context to the process, which is to generate data to an individual to be learned; providing reminders (e.g. nano or micro learning nudges); wherein the reminders reinforce the data to be learned, ensuring that the data is captured and learned at a greater rate.

In certain embodiments, there are W— number of nano/micro sessions 139 to continue learning. Indeed, there can be as few as one nano and one micro, and an upper limit is preferably no more than 100 nano or micro sessions for teaching, but an upper limit is not limited when the learning is for daily SOP, reminder, and the like. Thus, for teaching discrete skills, where a topic would require more nano or micro sessions, it may be too broadly defined and should be narrowed to have a specific focus to ensure mastery of the subject. By contrast, reminder learning for completion of tasks, does not need to have the upper limit. After the nano/micro sessions, in certain embodiments, an IPL 100 is deployed to meet person X face-to-face (virtual or in person). After that macro (IPL) session 100, post learning nano/micro sessions 125 are deployed. For example, these may serve as reminders, refreshers of specifics, such as a reminder to e-mail, reminder to do some action, etc. This causes the user to engage with the commitment that he/she has made.

We can then turn to an assessment/exam 107, for example, the user must identify which photo is person X or what does person X like to do, or to meet them on the job, at an event, or other application of the learned data. This confirms that the nano/micro sessions were effective in teaching the issue. Typically, each assessment requires a certain level of competence before it can be passed. Thus, if the assessment shows incomplete mastery of the topic, additional post learning nano/micro sessions can be initiated to ensure mastery of the topics before performing a re-assessment.

We can take these actions and monetize them 138 e.g., I made a commitment to bike with person X—we go onto a bike tour during our IPL team meeting, and we make a lead to a bike company that gets people to do actions. Securing the action leads to revenue being generated.

For example, in 137, I am on a cruise and I get to a new port. I want to do a ropes course and need ten people to join in order to do the ropes course. I would get a track including getting names/info of people and then we would share the track with a company to engage the activity based on the number of participants and do this activity with these people. All information then goes back to the database to the mosaic 130 and then the information then goes to the company to base on the goals of the company. We can use AI to identify the users who might have interest and find the 10 people to join, thus meeting the goal.

One use of this detail of the Track Cycle is to advance a company's corporate mission statement and the employee's personal mission statements. IVI (AI) is being implemented to have an individual advance in their personal statement as well as with the corporate mission statement—we are trying to get alignment between personal and corporate to get them to be who they want to be. In essence after completion, we determine the next 111 optimized learning module; this is the oscillating line at the bottom of the triangle (track cycle 120), where we define the next 111 track cycle to be completed.

Another example of the Track Cycle is as follows: the cycling through the full spectrum learning—nano, micro, macro—that someone cycles through for optimal learning for results. Each of these nano and micro sessions provides a drip of education and this can then be summarized or cemented through a macro session. Pre/Post can be done asynchronously, i.e. there may be certain assessments that happen out of order, and certain post learning modules that may be necessary from time to time. Pre-IPL (Synchronous workshop)—can be done on your own, based on your own needs for your learning and similarly, Post-IPL can be completed alone in or groups based on needs.

Ultimately, we strive to take the nano/micro learning and cement these learning spaces into the macro session. In certain embodiments, the macro session is an in person learning module, (IPL—gathering of persons, virtual or in person). In one sense, it is the collaboration of the group, a combination of all of the learning to move forward as a team. While in-person is optimal, modern technology allows this to also occur virtually.

Indeed, a component of this macro session is the sharing of the shared experience. Shared experiences, whether in person or virtual generate new learning opportunities and generate different bonds and teamwork than individual learning in the nano and micro modules. Once we have this team bonding, we can transition to post learning modules and then to assessments to complete the individual learning module within the track cycle.

The concept of the cycle is that we define in the systems and the methods herein that there is an adjustment from one session to a successive session, wherein the learning and the learning modules are thoughtfully organized to optimize the learning efficiency. We can identify, either as an individual or a company what is known, what should be known, and then apply importance to both the known and unknown. This valuation can be utilized to optimize the adjustment between a first and subsequent session.

Each cycle can be either linear, i.e. you need to know X and you take certain sessions to get to that point, or modular. For example, in learning X, you also need to know Y and Z, and if you don't know Y and Z, then the nano and micro sessions can be optimized to assist with learning those aspects. So, assessments can be utilized at points to ensure that the material being taught is proper for the individual and the team. Thus, you can use more targeted or background modules to ensure that X can be learned efficiently.

The goal of a single track is that you focus on learning a specific learning module and that the end provides mastery of that subject. Thus, you can update your mosaic 130 (database) with that learning module from your unknown to known profile within the database for the individual. Once you complete one track, the oscillating line is the adaptation so that you may have a different track that is optimized for the next learning module.

In every module, nano and micro learning sessions form a key component of a track cycle. Education has historically required a teacher and students, with the teacher lecturing to the students about certain content. However, that format ignores the variety of learning types and personalities of the students and is not optimized for efficiency for each student. Instead of an hour-long class, short snippets of educational material are provided to a user in these nano or micro learning sessions. However, and importantly, because the sessions are so short in duration, we can adjust content as necessary to optimize the education of the individual for the particular track cycle. Adjustment of the content is being performed in real-time. This is continually happening so there is content and content flavor (the way it is being distilled), e.g. a particular track is focused on the content of a “tomato.” Content may include information about the tomato, while flavor is a visual, oral, story, picture, etc. A subsequent track might then build upon the tomato and teach or determine whether everyone knows how to eat a tomato. We can then progress and a subsequent track is how to chop a tomato to help us now eat the tomato from the first track. Thus, we build upon the prior learned information to build an optimized learning strategy for completing education.

However, learning is more than just purely learning something new, it is the consistent application of the learned skills. For many, efficiency is gained where one can identify the specific tasks to be performed and then to be provided a reminder (e.g. a nano or micro session) to provide the SOP, a check list, an action item list, a protocol, etc. This can be provided daily, hourly, or as often as necessary when completing actions that are task driven. Through use of and generation of reminders, efficiency and optimization can be improved for employee and employer. Frequently, we can utilize modern electronic hardware, such as a smart phone, a wearable device, or similar product that allows for remote (away from a typical desk) connectivity.

As these features are described, a hardware device is critical to ensure that information can be communicated in two directions, i.e. to and from the device and to and from the server. Thus, when information needs to be pushed to a device, the device must be able to send and receive information, including time, location, and providing any additional materials necessary for completion of the task. Thus, FIG. 2 depicts a flowchart of a hardware device 1 and the communication with various components of a hardware device wearable 1. This device 1 communicates with a learning module 20, a check-in kiosk 10 (e.g. a location based element), a head set 70 (microphone and speakers), a predictive algorithm to define a next learning module 60 (i.e. the focus of the track cycle), a feedback manager 50, the mosaic 40, and an e-mail sever (a/k/a “Lemoul”) 30. Together, these features interact with the hardware wearable device 1 to ensure that the data from the device is shared appropriately within the database and other components of the system to enable optimized communication.

Connectivity and interaction between systems is paramount for optimizing the learning and interaction between a user and the device. For example, the check-in kiosk 10 is an example of a location-based connectivity. Other examples might include use of GPS, Bluetooth (or other short-range connectivity), RFID, geofencing, WiFi connection, or the like. The reason for connectivity is to confirm location of a device, often times at a particular time. Thus, by creating a connection, databases can track and identify the time and location of a user, and from there enable actions that will have this time and location stamp. Such information can be saved and stored within a database for connection to the remaining elements, including an e-mail server, the AI, the learning module, etc.

AI is preferably implemented within the systems to aid in communication between hardware sensors and components. In some applications, IVI can be a collection of sensors that may be mobile, for example as a robotic feature. Said robotic feature may comprise a housing, Cameras, Touch Sensors, Microphones, speakers, etc. Such robotic element may be able to display or communicate through projectors or speaker/voice boxes. Thus, if the robot (IVI) needs to share something visually, a user can say, “Hey, IVI, show me x.” IVI is then able to project visuals onto a surface. Using infrared sensors, the user can interface with the projection, for example, to select or type or draw. And responses to the robot can be captured through sensors.

Together, these elements on a robot provide data points from the environment that can be utilized to calculate and optimize actions of a machine or an individual. For example, IVI is present during an oral presentation from a first user being presented to a second and a third user. IVI using the appropriate sensors detects eye movement, sounds, etc., that are presented between the first user and the second and third users. IVI recognizes that during the presentation, the second user is not making eye contact and notifies the first use of the same, so as to engage the second user. Alternatively, IVI can notify the first user that the tone is becoming monotonous and then can confirm improvement of the same. All notifications can be provided via a wearable technology, i.e. a phone, or glasses or earpiece. This allows the first user to improve and optimize the engagement with the second and third users.

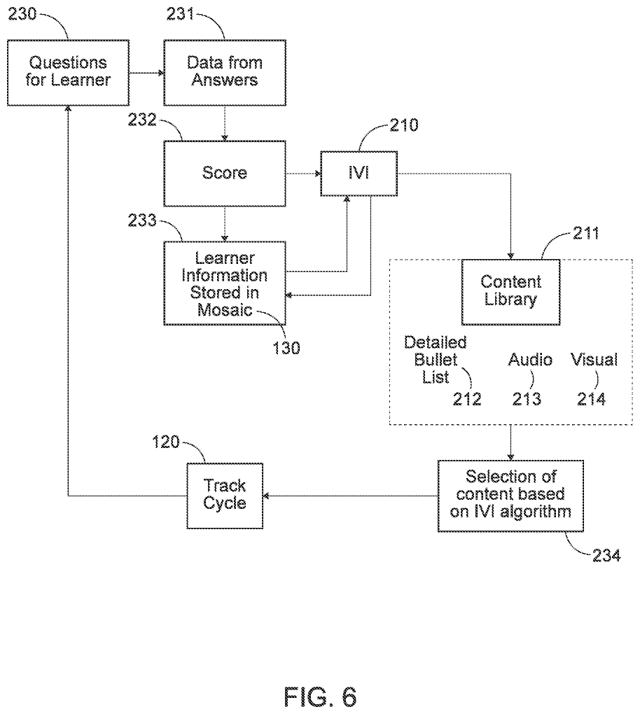

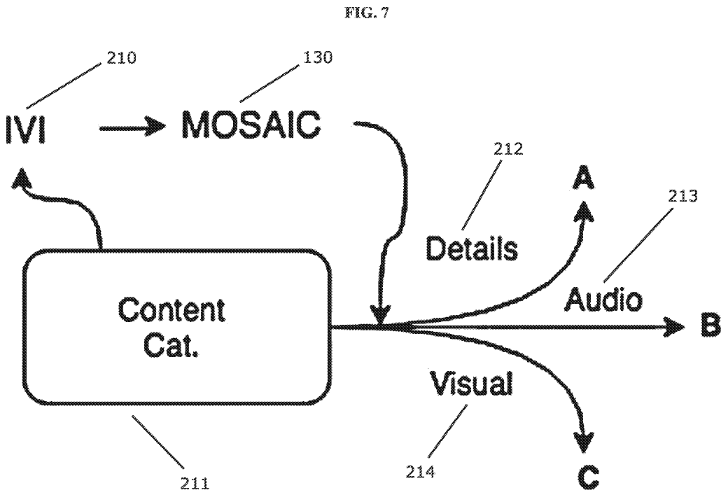

In the context of generating learning content and reminders to users, it can be helpful to modify the messaging provided to a user based on their learning type. FIG. 6 provides a picture of using the learning type and adjustment of content to generate both better contents targeted to the user and also for election of a track cycle 120 that gives both the proper type of content, specifically the right content subject matter to further education. For example, we begin with a track cycle 120, which begins with a particular topic, and generates questions for the user 230. The user answers the questions and this generates data 231 that can be tabulated as a score 232 and we can then store the information 233 within the mosaic 130. IVI (machine learning) 210 can then assess the stored information, for example within an accessible database to identify the learning type of the user and how the user is most likely to learn the particular subject matter being taught in the specific track cycle 120.

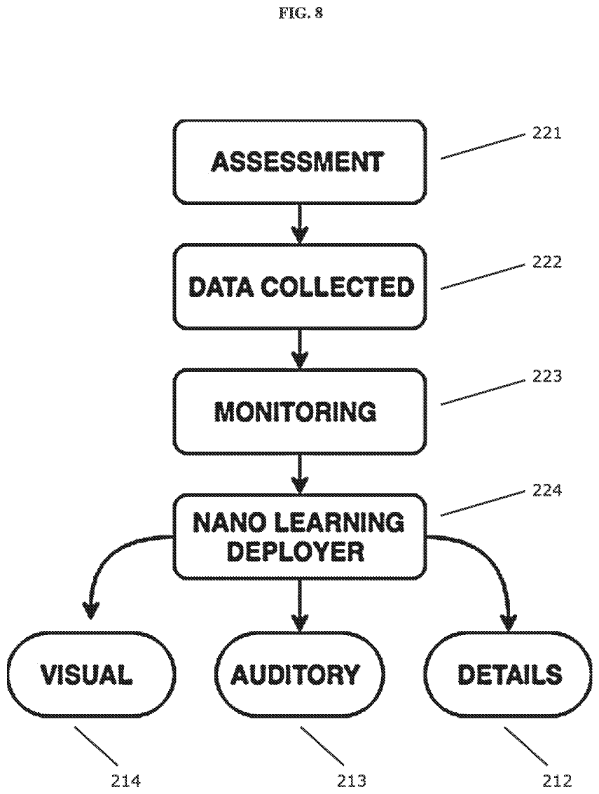

For example, if a track cycle 120 is related to whether an animal is a cat or a dog, a user might benefit from visual images 214, showing pictures of cats and dogs. By contrast, if the track cycle 120 detailed how to use a knife to cut vegetables, the user might not benefit from pictures of vegetables and a knife but, might do better using a video. Finally, if the task was to learn about how to differentiate song-bird calls from different species of birds, the user might prefer to hear audio 213 of the sounds instead of seeing the notes displayed on a music staff. Thus, the learning type for each track cycle 120 might be dependent on the specific task at hand. Using the power of machine learning through IVI 120, we can see what other similar track cycles 120 or information is within the mosaic 130 to best fit the type of learning that should occur for the instant track cycle 120. Then, we can utilize the concept of FIG. 7, for example, and use real-time feedback to evaluate the content 211 being delivered 224 and modify it on the fly, e.g. as in a nano learning session of FIG. 8 to a different type. Thus, feedback could recognize that images were not effective, and in the next nano learning session, provide an audio module 213, or a detail module 212 to try to teach or reinforce the concept that was not well understood from the visual session.

FIGS. 7 and 8 then details how, during one of these learning modules, the content can continually be modified. Content 211 is provided to the individual 220, and an assessment 221 is performed of the individual. The assessment 221 results are updated into the mosaic 130 and then we can utilize a feedback loop to make changes to the content 211 based on the information provided within the mosaic 130. Accordingly, if a user has an assessment 221 and shows lack of understanding of an issue in one instance using one type of learning and has another assessment 221 with a different type of learning, and that assessment shows excellent knowledge, we might infer that the second assessment 221 and content 211 was given in a way that was better digested by the individual 220. As more data 222 is received within the mosaic, we can better understand the learning type that is most useful for the individual 220 and modify the content 211 based upon the information in the mosaic 130.

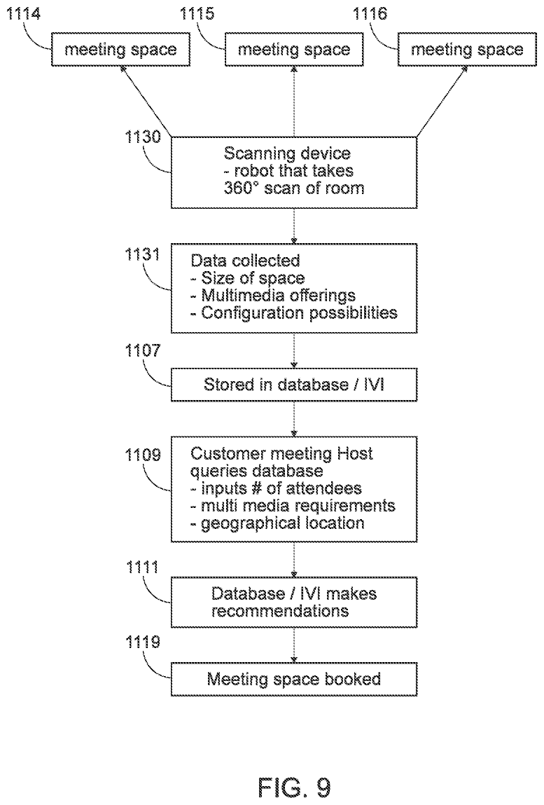

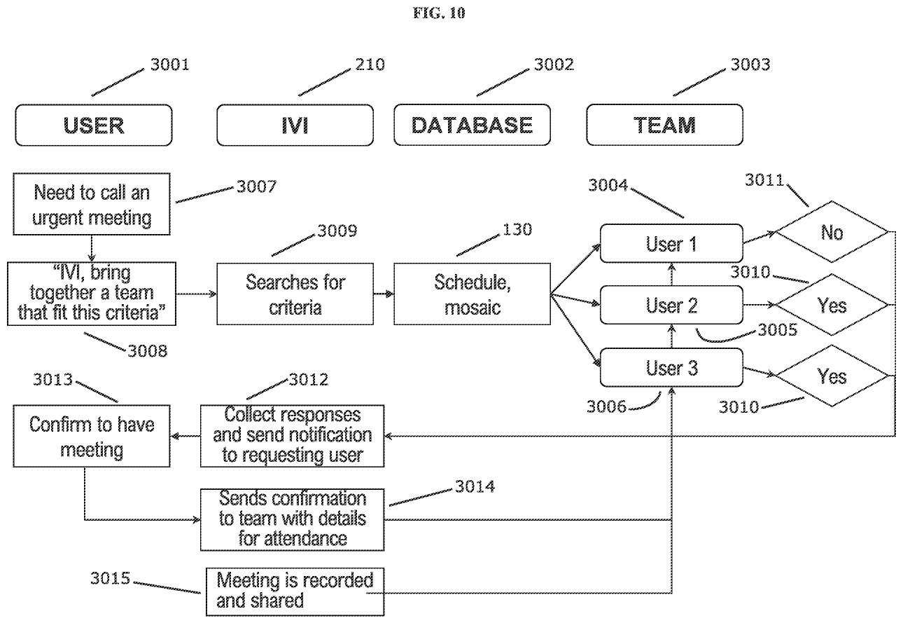

Individual experiences are also optimized by the surroundings. Whether this is for advertisements, presentations, meetings, dinners, concerts, and the like. Having the proper surroundings or venue can be critical to success in learning and in optimization of experiences. Therefore, optimization of the space and finding the attributes of a space to use becomes an opportunistic method and process in certain applications. Indeed, absent data and information on available spaces, we cannot optimize the solution for the users. FIG. 9 details a flowchart that outlines additional steps and features that can be utilized in methods and systems of the present disclosure. For example, meeting spaces 1114, 1115, and 1116 are unique spaces for which we need information about each space. Historically, space is manually catalogued and the expected maximum capacity identified as well as the nominal square footage of the spaces and even some images of how the spaces look and how others have filled the spaces. This information is inexact at best and misses the ability to maximize or optimize space. Instead, we need more precise ways to quantify space and we can then utilize that quantified data to identify solutions.

Thus, FIG. 9 details a scanning device 1130 that can be used in a space, e.g. 1114-1116. One scanning device is simply a camera that takes images that can then calculate space. However, a more elegant solution, as determined herein, is a robot or device that uses a 360-degree image of the location and can take a complete visual representation of the space for use. The robot can use a single camera to achieve this image, or multiple cameras can be utilized together to create images of greater acuity. Additional sensors may detect sound properties within the space, and precise measurements can be taken through use of images or through measuring devices, including optical measuring or through physical measuring of the premises. For example, a robot that is wheeled could move from one end to another to accurately measure a space if linear measurement through laser and/or image processing is not possible. This measurement can then be utilized with images to accurately determine lengths within the space using mathematical properties. Once the data is collected 1131 for the space, this information can be stored within a database 1107.

The database 1107 can then query all of the data collected and generate additional information about each space that can be matched to user demands. This database can then take information, or other inputs to compute a solution when asked a query. For example, as in FIG. 9, a query 1109 is sent to a database for the number of attendees, the number of multi-media requirements, and geographical location to be optimized. The engine 1111 makes a recommendation based on the inputs and the data within the database to optimize the various features of the inquiry. We can then identify a space from this recommendation, evaluate the space and book 1119 the space.

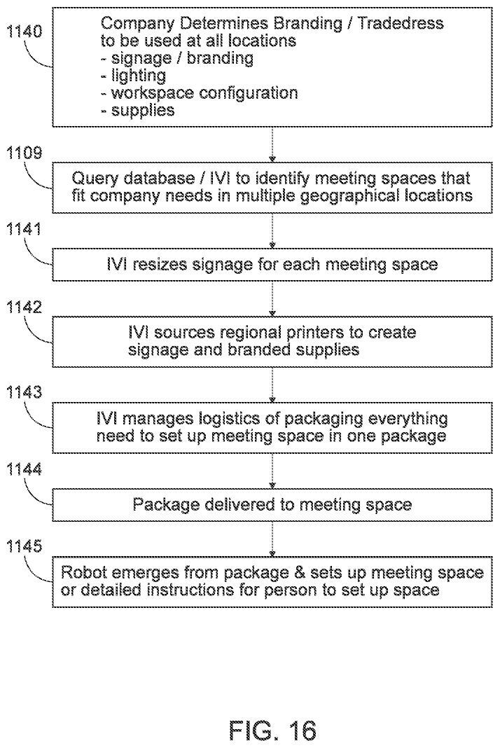

FIG. 16 expands the capabilities and the data we can ascertain from reviewing a space. Turning to FIG. 16, a company has determined branding and other materials that are needed or wanted for a meeting 1140. For example, branding or trade dress of the space to be used at one or a set of locations, including signage or branding, lighting, workspace configuration and other supplies and accessories necessary for fit and finish. We can query the database 1109 to identify a space that fits these needs. The engine (IVI) identifies a space and can automatically calculate and resize signage and other features that are going to be utilized within the space 1141. IVI then sources regional printers to create signage in the proper sizes, as well as other branded supplies 1142 and these components are logistically packaged 1143 in preparation for the meeting. A package is delivered 1144 containing all of these custom created components. Finally, after delivery, to set-up the space, a robot emerges from a package and provides detail instructions of placement of all components in the box 1145.

For example, there are twenty different custom wall signages, ten different table coverings, and accessories intended for different tables. By organizing the components within the box, and providing instructions to the robot, the robot can identify each component and physically move to that location and identify that feature X is to be placed here. For placing wall features, the robot can use sensors to assist in positioning, as it can scan the space and confirm or deny the placement based on the predetermined plan that was created when making and sizing the signage. Indeed, this predetermined plan is stored within IVI, and IVI then physically moves to locations or gives written or oral instructions to a person or team of persons to perform the installation. Accordingly, sensors or cameras in the robot can more efficiently confirm the proper placement of the predetermined materials and instruct their placement.

This allows one to overcome one of the typical space issues, where someone says that they want to use certain size wall coverings for branding and therefore needs a space that has those dimensions available to use to meet those needs. By customizing the branding by logistical supply, you can maintain the feel and trade dress of more spaces instead of requiring one that meets a very narrow set of parameters. This opens up more spaces to fit a business's needs, which benefits both property owners and also lessees of spaces.

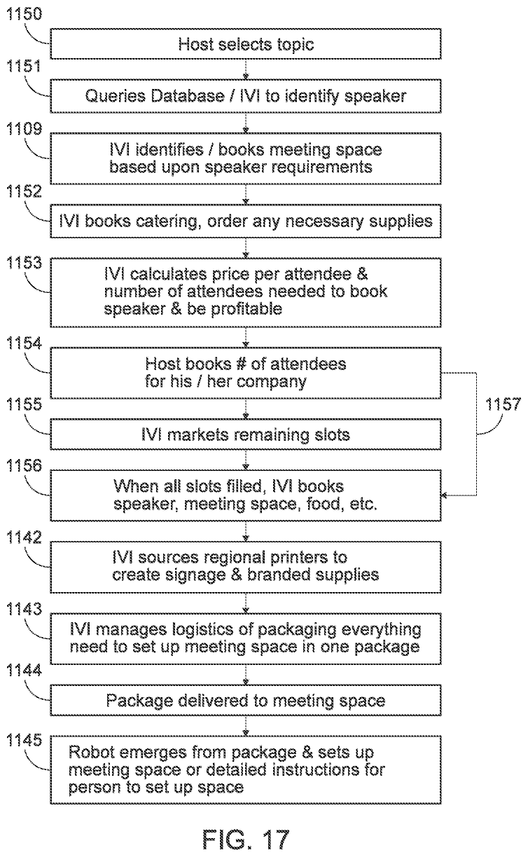

FIG. 17 engages a further step that is common for meetings or presentations, namely the booking of a speaker for a particular topic. Most meetings or presentations have some formal speaker or host. One issue that faces these sessions is the need to fill a sufficient number of spaces/paid attendees, to allow for the session to be profitable. For example, a speaker who is an expert on e-gaming wants to hold a teaching session in city X to provide a presentation on new strategies for e-gaming. The speaker normally wants to receive $500 for his time, plus travel and other fees, for a total package of $1000 for a session. Each participant normally pays $50 to attend these sessions and the space and overhead costs Y dollars. We can quickly calculate the number of attendees that we need to meet the $1000 threshold by calculating $50Y, to give Z number of attendees. Once this Z threshold is met, we can say that the speaker will be paid in full and the session would be profitable.

Accordingly, FIG. 17 details that the host selects a topic 1150, in our case above about e-gaming. The database is queried 1151 to identify a speaker on the topic. The above speaker information about her financial costs can be a datapoint in the database, and we then query the database further 1109 to identify spaces that would meet the Z threshold of number of attendees, based upon the Y cost. IVI can book catering and order supplies 1152 to meet the necessary steps for holding the session, and these points are calculated 1153 based on the attendee price, number of attendees, etc. to ensure profitability.

A host can identify the number of attendees booked 1154, e.g. from a particular group or business that will attend the session. Assuming this meets the Z threshold, the session is booked and proceeds 1157. If, however, the Z threshold is not met, IVI markets the session 1155, with approvals of the host, and finds additional attendees. Upon receiving more paid attendees and meeting the Z threshold 1156, the session is finalized and booked and proceeds 1157.

This allows for logistics to finalize features, e.g. from FIG. 9 to finalize signage 1142, and prepare the space for the session 1143-1145. Accordingly, we describe the use of databasing systems to capture data from individuals and spaces, and then to capture needs for in-person sessions and query the databases to identify and optimize the space.

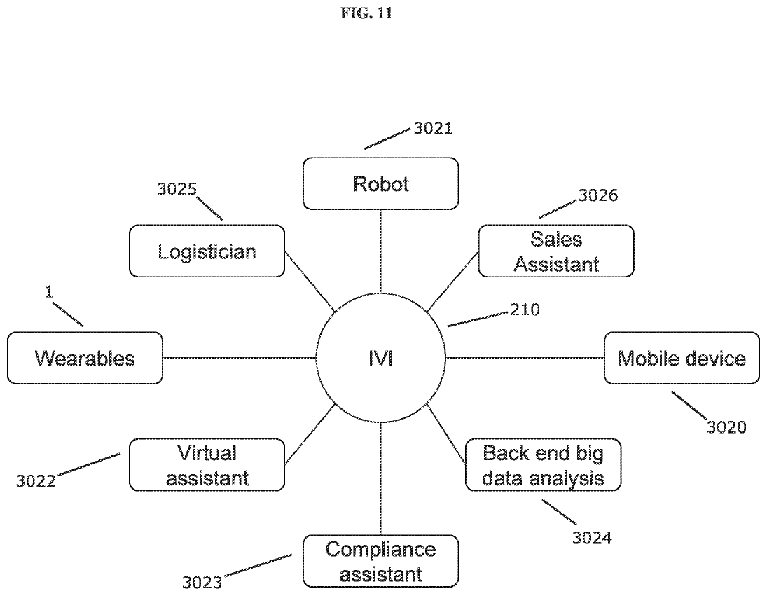

In certain embodiments, it is advantageous to utilize the learned tools of an employee pool to maximize efficiency when needed. FIG. 10 depicts how IVI (AI) 210 can call together a team for an impromptu meeting 3007 at any given moment. A particular user, e.g. “John” 3001 just got off a call with a client and the client is a significant one and needs something unique, and they need it fast. John 3001 is able to communicate (verbally or through text) 3008 with IVI 210 through his mobile or wearable device 1 into written word and to organize his team 3003 rapidly. John 3001 may say, “IVI, I need to talk with my product team, and I need a marketing person who is a graphic designer on the call.” IVI 210 can translate the spoken language into text, which can be parsed. IVI 210 would then surf 3009 through the company's calendar 130 and optimize the skill sets and personnel 3004-3006 for the task. IVI 210 can send out a notification, which may be on a smartwatch, that says, “Urgent meeting requested by John for Client x. Can you join call in 15 minutes?” Each individual can respond in the affirmative 3010 or not 3011. John 3001 then gets a report 3012 from IVI 210 (in the way best suited to his mosaic, which in his case is audio) that says, “John, 90% of your team can join a call in 15 minutes. User 1 cannot join. Proceed or wait for User 1's availability?” John 3001 confirms 3013 that it's okay to proceed without User 1 3004 and says, “IVI, that's okay. Just record the call and send a copy to User 1 after we've hung up.” IVI 210 then sends call-in information 3014 to all team members and the meeting is recorded 3015 and shared with the users later. Thus, these notifications, while different in scope from the learning notifications, function to notify users of opportunities and actions that are necessary. Thus, where an SOP is necessary for completion of a task, so, too, is response to a directed inquire necessary for completion of a different type of task. Thus, the concept of and application of directed notifications has many different layers to optimize and increase efficiency within the workplace.

Through such communication, identification of potential users to assist with a project allows for AI to integrate with a database system 3002 to aid a specific user, e.g. John 3001, to optimize and solve a client issue through optimizing the team members available at his company. Namely, AI can identify team members that, through experience and prior successes, or through other mechanisms, show compatible skills to optimize and solve a client problem. This provides a unique method to utilize databasing systems to optimize and generate team members and to allow for response and integration of additional activities, i.e., of recording a call and then mailing to certain users the recorded call, or other aspects as necessary to optimize team formation and project completion.

FIG. 11 is a map of the many different ways IVI (AI) 210 may manifest itself to users. IVI 210 defines artificial intelligence that can be integrated into any device. For example, IVI 210 can be a collection of sensors and/or displays within a robot 3021 that can walk about and interact with humans or other machines. IVI 210 can be on a wearable device as a communication and actuation tool (receiving instructions and fulfilling tasks). IVI 210 can be on a mobile device 3020. IVI 210 can be a logistician 3025. IVI 210 can be a virtual assistant 3022. IVI 210 can be a data analyst in the back end 3024 serving reports to administrators. IVI 210 can be a sales associate 3026 or a compliance associate 3023. However, through creating searchable databases and collection of data from learning modules, from individual users, from assessments and the like, we can capture data within a system that can be mined and trained using neural network strategies to define AI optimized for the company solution.

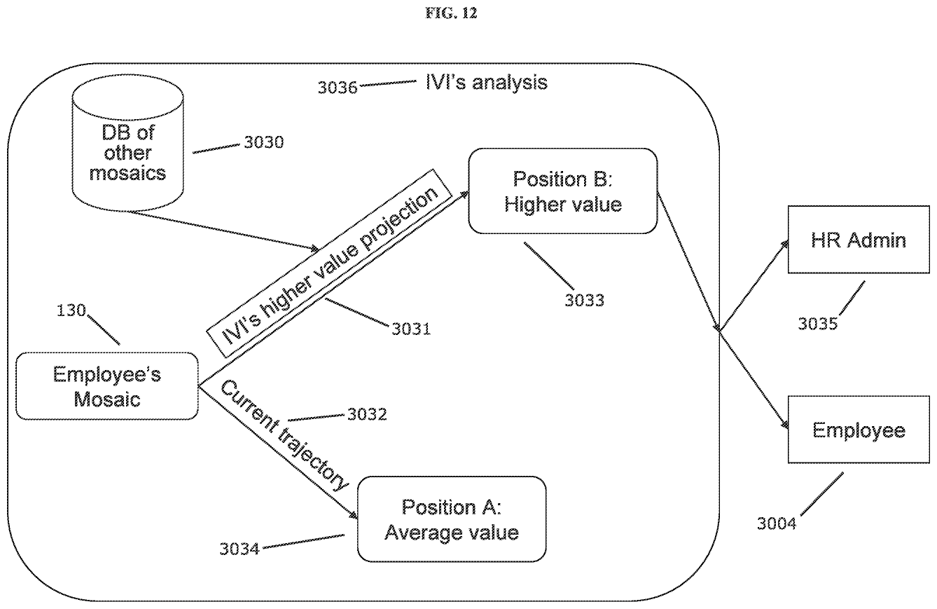

FIG. 12 depicts a flowchart of how IVI is a personal and professional growth guide. IVI is not only the algorithm that adjusts for the next learning track (IVI is what makes the learning cycle cyclical) for the business path established by your administrator/manager, but it can also identify an ideal fit for a user's personal mosaic in a different line of work or position and suggest the learning tracks for you to get there. For example, if an employee 3004 currently is an engineer 3034 at a company and is becoming a more valuable engineer by doing learning tracks, the employee's mosaic 130 is filling up with information about his/her personality type, competencies, etc.

Simultaneously, a top salesperson in the same organization is completing their learning tracks, too 3030. IVI notices 3036 that as an engineer, the employee's 3004 value is average. When it projects 3031 that employee's mosaic 130 in a sales role, he/she matches up very closely 3033 with a high performing salesperson. IVI then push a notification to the HR admin 3035 and the employee 3004 individually that says, “Have you considered being a technical salesperson? I noticed that your mosaic is 98% like the top 5% of salespeople in your organization and is 85% like technical salespeople across multiple industries.” This is an example of how IVI can help individuals and businesses grow and be more valuable, but also how to bring overall enterprise-level value beyond individual learning, by allowing large data collections to identify trends and relationships that may be difficult to see on a surface level.

Furthermore, this can generate tremendous value to an organization as we can optimize the work at which employees are highest performing. Ultimately, when open positions are filled, it can optimize whether persons within the company are a good fit for the open position. In one example, a simple promotion to a new position can be filled internally, and the lower position filled externally. This may proceed through several chains, e.g. two or more positions may be filled internally until a lower position or bottom position is reached. This provides a classic example that one can be promoted from the bottom up in a company.

In another scenario, we can check for a pool of external candidates and request information from these external candidates sufficient to use within IVI, to calculate their fit score for the open position and rank them against internal personnel options to fill. The system can further evaluate and compare when two personnel need to be evaluated. For example, we can identify a set of external applicants and a set of internal applicants. We can then check the fit of external applicants for both the open position and the positions that would become open if we fill the position internally. Thus, the company can see whether it is easier to fill the open position or the position that would become open by an external applicant based on a best fit score calculated from the know profile of external applicants.

Turning to a different application of using reminders and education of employees, there are numerous businesses that require consistent review and responses based on law or safety. For example, in many situations, first responders or police forces are required to track and log their actions. Reminders can be helpful to allow entry of this information while capturing the specific time and location of the responder at that moment.

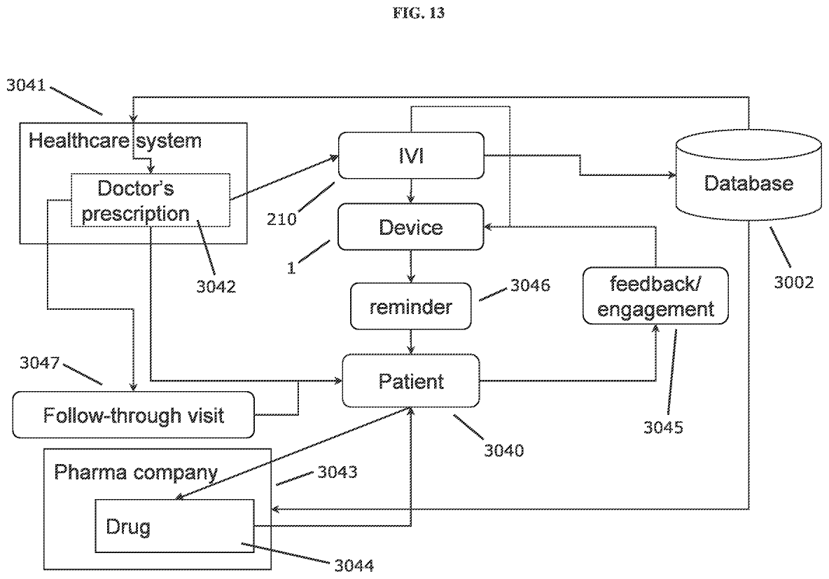

Healthcare providers and patients within healthcare systems often face these issues, both with regard to location but also with regard to timing. Beginning with a patient 3044, FIG. 13 depicts how IVI 210 is an engagement steward for healthcare. It is critical that healthcare patients adhere to their prescribed medical programs 3042. This embodiment focuses on taking pharmaceutical drugs 3044. This embodiment could be utilized by any individual, alone or in conjunction with a pharmaceutical company 3043 or healthcare provider 3041. A patient 3040 has IVI 210 present on their mobile and/or (preferably) on their wearable device 1. The healthcare system 3041 wants to know that the patient 3040 took their medicine 3044 on time. IVI 210 is charged with ensuring that the patient 3040 does so with notifications 3046 and a feedback loop 3045 that says/confirms, “Yes, I took my medicine.” This is logged 3002 across the countless patients, and the data can be collected to provide assistance and guidance relating to adherence of the prescription 3042 or not. This data can be queried by the doctor, for example, when the patient 3040 says, “It's not working,” and then the doctor can ask IVI 210, “How consistent is patient x in taking their medicine?” and IVI 210 will report that they, for example, are very inconsistent in taking it at the right time and in fact didn't take the drugs 3044 for three days in a row. Furthermore, the pharmaceutical company 3043 would be interested in patient compliance to ensure safe use of the medication 3044 and proper treatment to achieve better outcomes. Accordingly, a notification can be provided to the patient 3040 that is a reminder 3046 to take medication, and in certain embodiments also include a follow-up 3047 with the patient by asking 30 minutes after they said they took their drug, “How does your head feel from 1 to 5?” etc. and be receiving geo-location and biometric feedback concurrently. This information can be made available to the doctor, also, to better help customize the patient's healthcare.

In certain embodiments, a pill container contains an RFID or beacon, which allows the patient 3040 to confirm taking a medication only within proximity of the beacon. This provides proximity and time stamping abilities to aid in compliance in taking a medication.

This could also be the case in physical therapy, or other non-pharmaceutical health care systems. For the example of physical therapy, IVI 210 may be able to pull data from sensors to say, “You're not extending far enough,” and simultaneously provide that data to the therapist but also guide the patient 3040 to complete the motion as prescribed, or say, “Don't forget to do your stretches today.”

Similarly, this can be utilized by a healthcare giver to ensure better compliance and care to a patient or patients. For example, a nursing protocol for outpatient nurses requires a daily check-in with a patient at their home location. Using location services and time stamps, the embodiments can provide a notification to a healthcare provider when that healthcare provider is proximate to the patient, which can be determined by any number of location based services, such as WiFi, GPS, cell phone positioning or a Bluetooth (or equivalent), RFID, or other short wave connection. This data, plus the time stamp can then identify the location and time a healthcare giver arrives. In certain situations, care is required for X amount of time for proper care and reimbursement. Such systems can track arrival and departure as confirmation of the time spent at the location.

Furthermore, applications within the system can be engaged based on the location services being activated. For example, if a geofence is provided around a location, and a device enters that geofence, new features can be enabled. Thus, upon entry to a geofence, a list can be provided with patient care instructions/reminders. Furthermore, the application can generate a checklist for confirmation, but only within the geofence. This allows a caregiver to confirm that tasks were performed, when the caregiver is present within the geofence or with the location-based services. This allows for contemporaneous confirmation of the checklist and thus increases chances for better patient care and better patient results, while providing the healthcare provider with evidence of the support provided. Thus, such a system and method can benefit all parties.

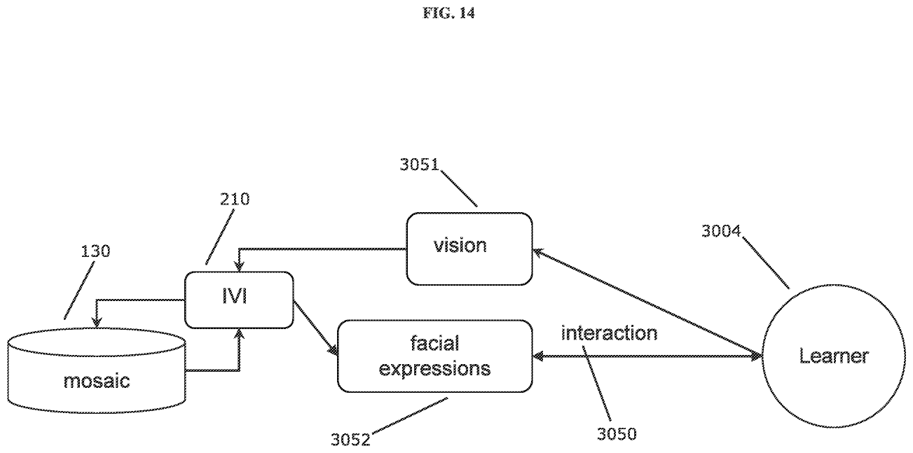

In other embodiments, AI can be utilized in conjunction with certain sensors and features that allow for capture of biometric data, sensory data, and to utilize this to optimize response and communication. For example, FIG. 14 is a flowchart of how AI 210, perhaps implemented within a robot comprising a plurality of sensors, can use computer vision 3051 and interaction 3050 to acquire information for an individual's mosaic 130. For example, Johnny 3004 is taking a workshop on how to make compelling eye contact. As simulated training, Johnny 3004 can interact with IVI 210 as a robot. While Johnny 3004 is talking, IVI 210 is responding intelligently to his body language and questions. Furthermore, with a humanoid face, IVI 210 can simulate different facial micro-expressions 3052 to see how Johnny 3004 reacts. Even more so, IVI 210 can read Johnny's facial micro expressions 3052 to learn more about his underlying personality and psychology. For example, it is possible to detect depression and other mental conditions by pairing vocal tone with facial micro expressions 3052. IVI 210 would be able to do all of that in the midst of any interaction 3050 and supply that information to Johnny's mosaic 130.

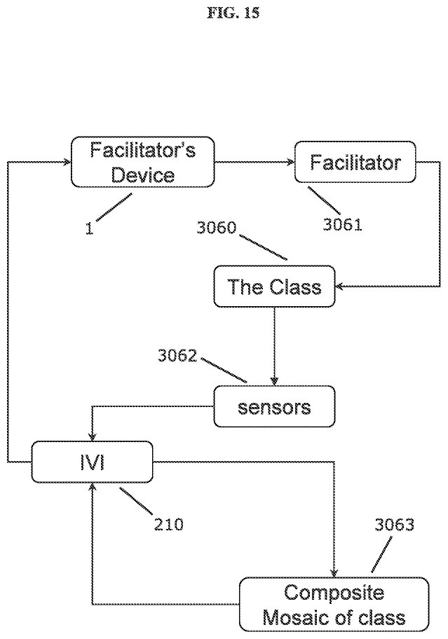

FIG. 15 similarly depicts a flowchart of how AI (IVI) 210 can assist facilitators 3061 of in-person learning. Using similar sensors 3062 and analysis of data in FIG. 14, IVI 210 is able to push notifications to the mobile and wearable devices 1 of a workshop instructor, Becky 3061, for example, to create a more compelling, engaging, and fruitful in person learning experience. If in minute 13, for example, IVI 210 knows that 75% of the audience 3060 is constructed of a number of individuals who are known to be impatient (because we know who checked-in) 3063 then IVI 210 will be watching closely for fidgeting. When it is detected, IVI 210 will notify the facilitator through their watch 1 with something like, “They are fidgety; tell a joke or have them stretch.”

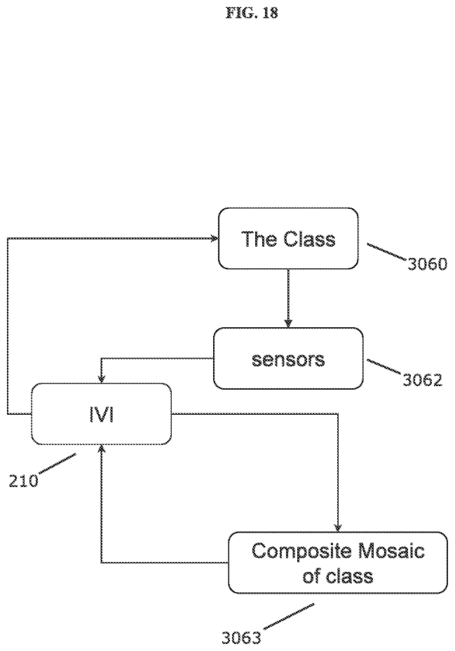

FIG. 18 depicts a flowchart of how IVI 210 may be used as a source of entertainment when there is a lull in a meeting. For example, there is a meeting 3060 of ten people either for a workshop or for a business meeting. IVI 210 notices 3062 that there is low engagement in the room and attention is waning. Pulling from the mosaics of the individuals in the room 3063, IVI 210 tells a joke or does something that will entertain the attendees. Attention and engagement are thusly increased.

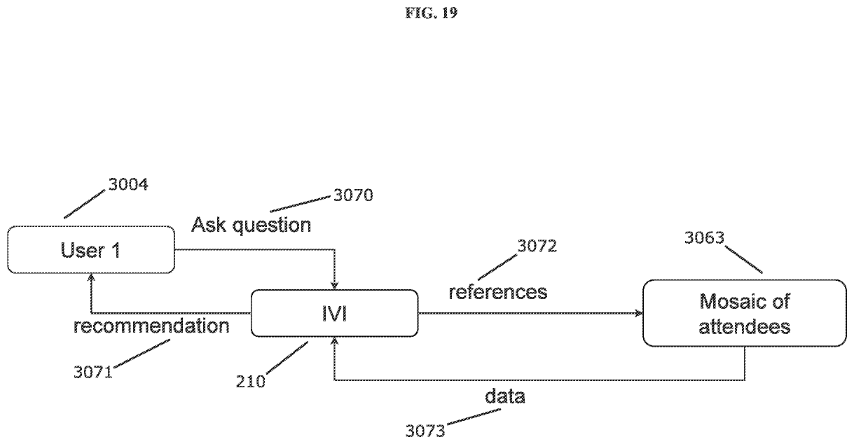

FIG. 19 depicts a flowchart where IVI 210 recommends 3071 how to position content in a business meeting presentation for optimal intake from the audience (content includes information and format of presentation). User 1 3004 is presenting her recommendations to a group of colleagues. Before she creates the content for the presentation she consults 3070 IVI 210: “IVI, how can I make this presentation catered to those who will be attending?” IVI 210 then looks at the calendar invite, refers 3072 to the mosaics of the individuals 3063 invited, and creates 3073 a recommendation 3071 for those people. This uses similar technology that would be used for the real-time adjustment of information for individuals and groups, but instead of IVI 210 making the content, it can offer its recommendations 3071 to the creator 3004. An example recommendation might be, “They are mostly engineer brained, so be very detailed and diagrammatic. Also, they are more kinesthetic than audio, so bring in a physical prototype they can touch.”

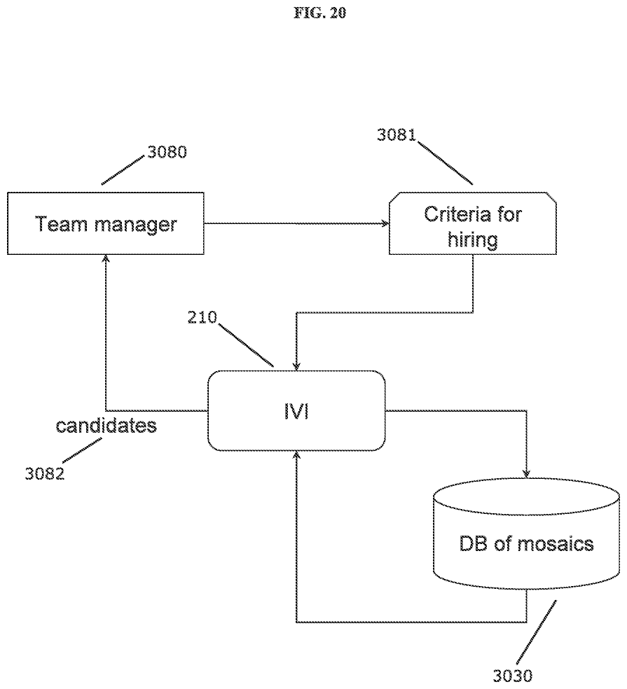

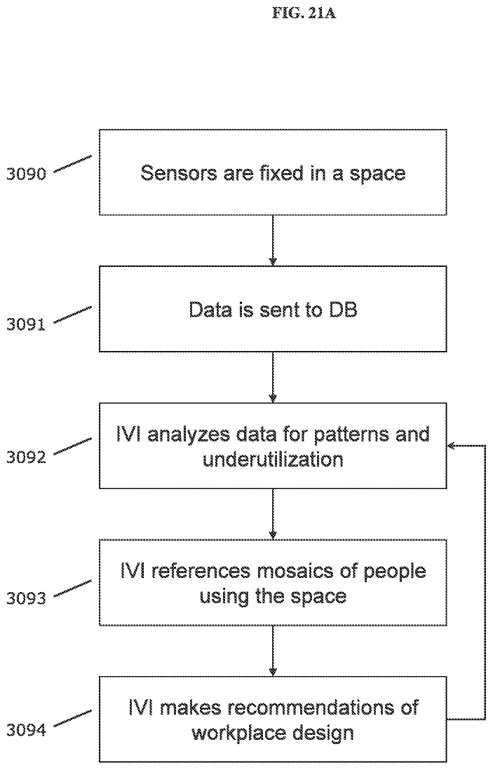

FIG. 20 depicts a flowchart of how IVI 210 can assist a team manager 3080 to make hiring decisions. Sally the team manager 3080 has a team that is growing. She needs to support the growth but wants to ensure that there is balance not only in skill-set requirements 3081, but also that the personalities of the individuals are optimized. For example, if the team was only made of extraverts, then they wouldn't be as successful as if there was a healthy mix of intra- and extraverted people. She could ask IVI 210, “I need a person with data analysis skills. Can you recommend what personality type would be ideal for the team?” In a world where mosaics are a standard part of the workforce, as resumes are today, Sally 3008 could query a national database of mosaics 3030 to identify specific individuals 3082 who fit the need.

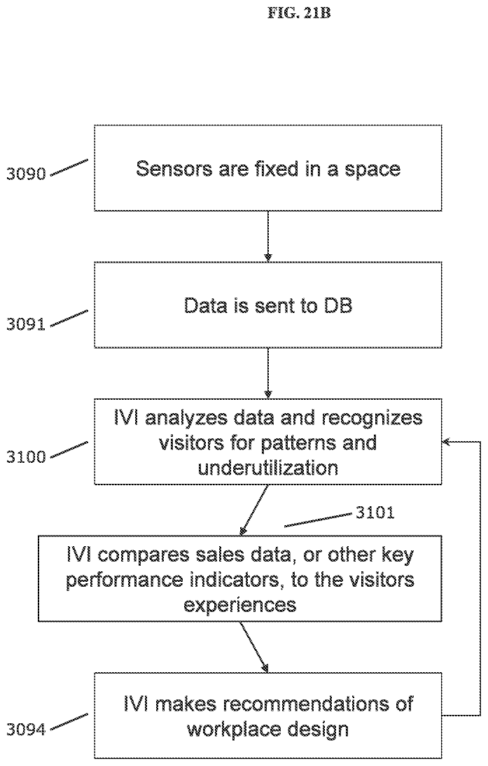

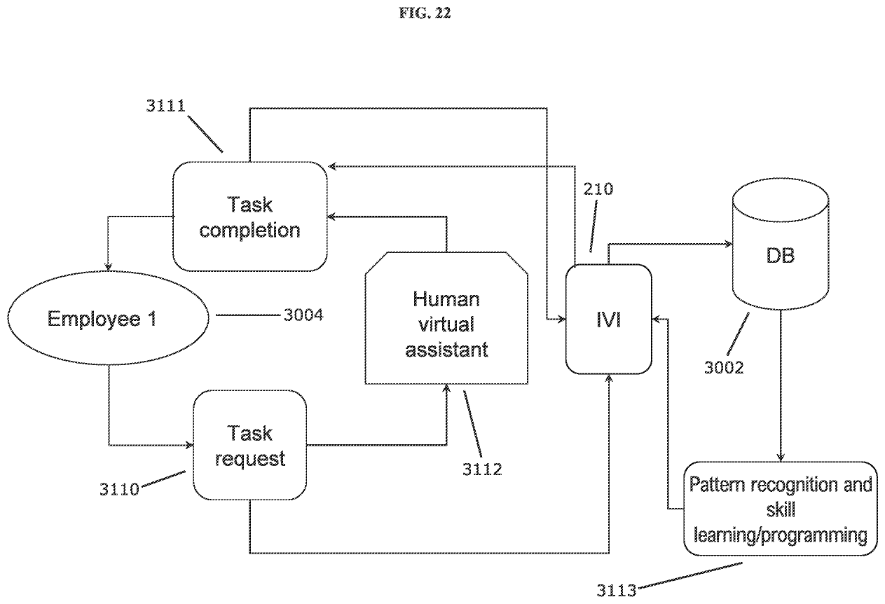

FIG. 21A depicts a flowchart where IVI optimizes the physical set-up of a workspace. A licensing scenario for this embodiment of IVI is ideal for a commercial furniture rental company, “ABC Co.” A finance company is moving into a new space and hires ABC Co. to set up the space for optimal workflow and to use their furniture to outfit it. As part of the design are strategically placed sensors 3090 that monitor movement of people and utilization of items like fridges, pool tables, couches, etc. 3092. The sensors also can track the movement of mobile and wearable devices. ABC Co. would license IVI to suggest changes 3094 to the furniture and outfittings based on observation of usage 3091 and the collective mosaics of the employees 3093 at the finance company. For example, there is a corner of the office that has a library but no one is utilizing it as observed by the sensors 3090. IVI would identify that this space is underutilized 3092 and could be repurposed. The mosaics of the team 3093 are such that it is clear that they love physical fitness. IVI suggests 3094 that the repurposed area should be a gym and that ABC Co. can supply that equipment. IVI then repeats this process 3095 constantly optimizing.

Similarly, in FIG. 21B IVI can identify when guests come and how they move throughout the space 3100. This is interesting especially for companies that invest in visitor experiences as part of their sale process. The monitoring of those individual's movements and lingering is informative to make a better experience to generate more sales 3101. IVI then repeats this process 3095 constantly optimizing.

FIG. 22 shows an example of IVI acting as a personal virtual assistant to users. Company X believes that every employee should have the tools of an executive to provide optimal output and productivity. Part of this is to provide a virtual assistant 3112 to each employee 3004. After three months of submitted requests 3110 to their virtual assistants 3112, IVI 210 is able to machine learn 3113 the most common repetitive tasks that the assistants 3112 are performing. IVI 210 learns/is programmed 3113 how to do those tasks and IVI 210 takes over those tasks 3111, saving the company money. But then the next level to that is that unlike the virtual assistant 3112, IVI 210 knows how to make all the interactions with that employee 3004 customized to their mosaic in every moment. Such a thing performed by a human would be very challenging and very expensive to find someone that talented to manage many different identities and serve them all to their strengths. The way we as a provider of this service create this learning environment without the employee 3004 knowing is that they are always submitting their requests with IVI 210, not Jane Doe the virtual assistant 3112. Slowly, without the employee 3004 necessarily needing to know, we supplant the human with a robot. This is how we centralize all the requests in a database 3002 that a machine can learn from 3113.

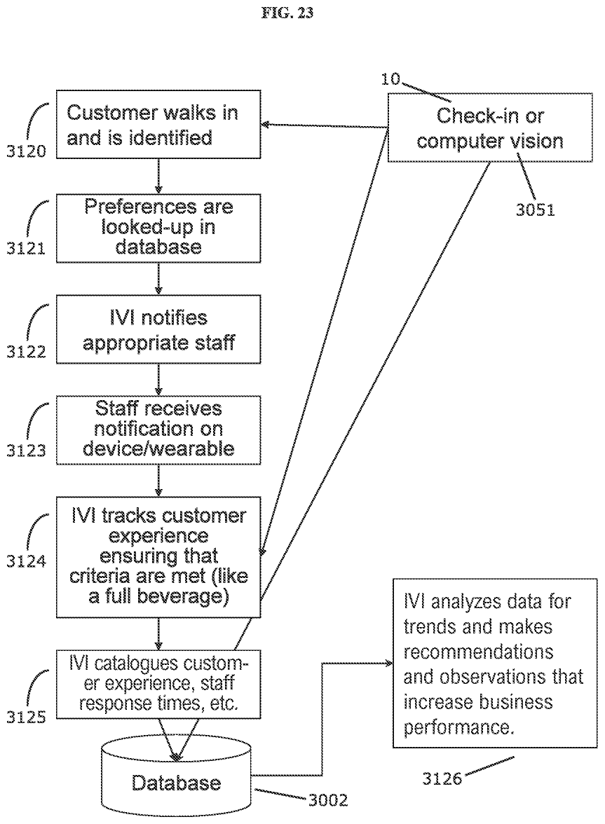

FIG. 23 depicts a flowchart where IVI identifies a customer, their preferences, and synchronizes that customer's experience with the wearable technology of the staff to support that experience. For example, Joe walks into a restaurant 3120. He's been there many times and prefers to drink Diet Cola and is gluten free 3121. IVI utilizes the cameras in the facility recognize him and let the staff know 3122 that Joe has walked in. Alternatively, Joe can “check-in” so IVI knows he's there. The server's watch 3123 says, “Joe is at table 7.” The server is then able to customize the experience to Joe even if it is the server's first day on the floor. “Joe, would you like a diet coke today?” 7 minutes in, the cameras see that Joe's drink is empty 3124. IVI then notifies the server that Joe needs a refill. IVI catalogues and stores data from each of Joe's visits 3125. This information is stored in a database 3002 and provides management with reports to guide business decisions and increases productivity 3126. This service could be applied in a shoe store where a customer is recognized and IVI can guide the salesperson to serve those customers to the best of their ability. IVI can then begin drawing trends such as “when servers gave water to customers when they are looking at shoes, it increases sales by x % 3126.

Companies can license this technology and instead of “IVI” it could be their mascot/AI identity like the Philadelphia Fanatic that tells the walking beer distributor that Joe in seat 32C likes a beer in the bottom of the 4th inning. Joe checks in and it's the Fanatic brand that greets him but IVI that is running the back-end.

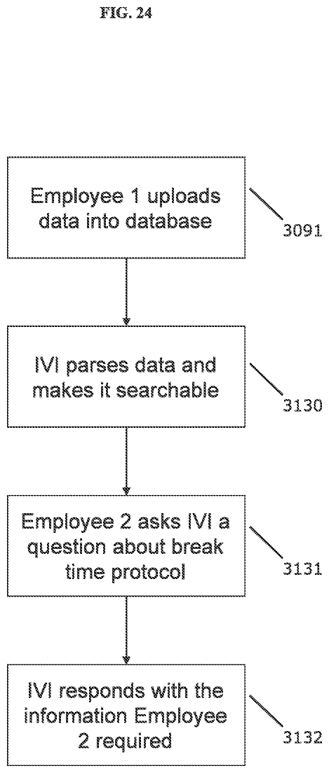

FIG. 24 depicts a flowchart of how IVI 210 can be a compliance assistant. Employee 1 is in charge of onboarding. Employee 1 uploads the employee handbook 3091 into IVI 210 as raw content to be processed, databased, and made queryable 3130. Employee 2 is new to company and has a question about break time procedure. Instead of asking Employee 1, Employee 2 is able to ask IVI 3131. IVI then searches its database and responds with the information 3132.

Accordingly, AI (IVI) functions as an intelligent system to take data from a database or sensors and optimize the situation. IVI can be programmed by training on a data set via machine learning, and we can optimize the particular aspects that have a greater priority based on machine learning. We can utilize multiple mosaics to ascertain success and failure and use these as the datasets for training. Simultaneously, we can train the system for facial expressions, voice tone, biometric numbers, etc. to optimize and enhance particular interactions based on the most optimal outcomes from the datasets. These can then be utilized together with a robotic element, that captures data from sensors, to create unique learning systems and outputs to generate optimization for a user.

In certain embodiments, hardware utilized within the systems and methods can be a wearable device. In preferred embodiments, this hardware device further comprises a receiver and a microphone, wherein a user can speak into the hardware device and the hardware device can use natural langue processing to determine what is being dictated into the hardware device. For example, a user walking into the workplace says, “IVI, please start timer for Project X.” IVI will then start a timer and include data regarding location and status of the user. For example, is the user at work? Is the user moving while at work? Is the user actually outside on a smoke break when user said they were at some other location. A user can then complete a task and say, “IVI, please stop timer.” or “IVI, complete time with Project X,” as non-limiting examples. User can also give notes on the meeting, for example, “IVI, note that I discussed project X with persons A, B, and C, and address concerns.” This can be emailed or uploaded into further processing documents, for example time entries or billing entries. IVI can also assist with rating the engagement, adding notes about movement, heart rate, blood pressure and other biometrics, location, etc., during the time. IVI can also ask if meeting is over, for example if user moves locations or changes some parameter that can be identified as non-related to the event. Accordingly, hardware can be utilized to capture data, capture voice data, capture instructions, and to assist with time keeping and management of the same.

The time keeping aspects are advantageously utilized alone or in combination with any of the embodiments described herein to generate additional functionality, time keeping, note keeping, or data management.

Customer service, customer details, optimizing client requests, each provide an opportunity to generate a better product or result to a customer. The difficulty is how to generate better customer service, how to provide customer details, and how to optimize client requests. Beginning with customer service, the issue is typically how to diffuse a situation and to maintain a relationship with a customer and simultaneously solve the problem. For example, a customer is upset over some issue. How can we reach the employee who will engage with that customer, teach that employee about the customer issue, and how the employee can assist in reducing the frustration of the customer through technology? Herein, embodiments of how to solve this problem are detailed, whether to deliver nano content, micro content, or modify other aspects to improve the exchange. In all instances, the embodiments herein detail providing reminders (a nudge) to a user, wherein the reminder can be utilized to improve the outcome of the event.

In other embodiments, we can capture information about individuals and can optimize environmental aspects for a person to generate a particular emotion to that user. For example, each person has a preferred environment like smell, light intensity, light color, types of music, etc. When an individual checks-in at a new spot, desk, or room, we can use the Internet of Things (IoT) to adapt the setting to that person's preferences. We can capture this information within a database (mosaic) and then automatically perform these updates to a particular location. This is not dissimilar to the concept of how a user interacts with a web browser, where the browser stores all of their preferences and login credentials, which are nearly instantly available and implemented in their internet browsing experience. In essence, such optimization can be performed for a workspace.

Accordingly, to optimize workplaces, we can begin to evaluate training and knowledge of employees and staff. In certain instances, we can best optimize interactions between employees and customers through education and training that will present workplace situations that can arise with both customers and co-workers and how to address them. In other cases, education can expand the user's knowledge of how others might view a situation, and thus have better situational awareness of their actions, tones, words, etc. Accordingly, in certain embodiments, education and continued education is important for optimizing interactions. Furthermore, certain of the track cycle elements, as described below, can be utilized to capture information about users, and therefore we can use such data for other optimizations, including sights, sounds, feel, lighting, etc., based upon their track cycles and assessments therein.

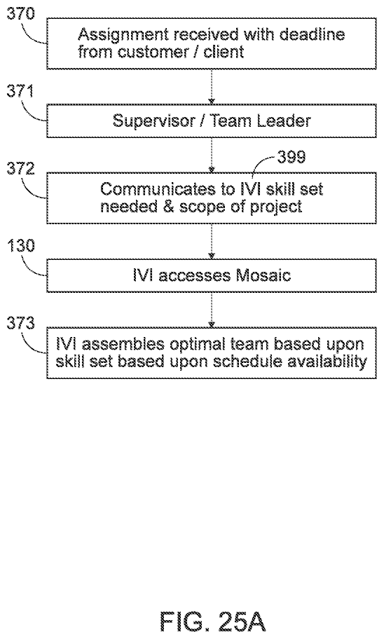

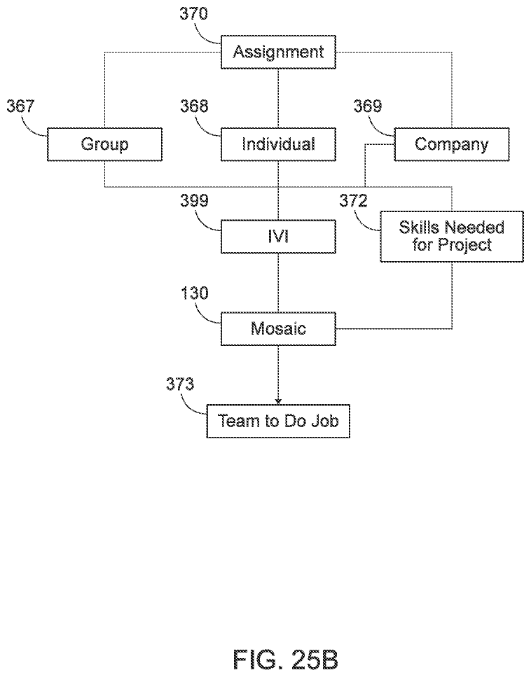

Thus, when optimizing workplaces and interactions between workers, there is room to create more efficient methods of optimizing. Take for example FIG. 25A. An assignment is received with a deadline 370 for a particular customer or client. The assignment can be provided to a supervisor or team leader 371. In some cases, e.g. FIG. 25B the assignment requires a group 367, an individual 368, or a company-wide 369 effort to complete. A team leader 371, thus can be just the individual, if that is all that is needed to complete the project, or the leader of a real team including one or more additional people. The supervisor (team leader) 371 communicates to IVI 399 a set of skills necessary to complete the project 372. This might be specific skills, i.e. coding is needed, so only people that code are needed. Others might require someone to perform a medical procedure for a particular patient, thus needing that doctor, etc. IVI 399 serving as the brain trust, can access the mosaic 130 of all employees. The mosaic 130 serves as a database of all the skills of each employee. In this manner, the mosaic 130 uses blockchain or other system to verify skills and abilities, and thus the items in the mosaic 130 are verified and not user generated. IVI 399 can then assemble a team that can best be optimized to solve the problem.

For example, a customer needs a solution and has a deadline of 24 hours. In such a situation, we can create sets of skills needed to complete the project as well as timing as a parameter. This allows input of the variable to ensure that we find only personnel that are available to work on the project during the next 24 hours to get it completed for the customer. We can utilize IVI 399 to access the mosaics 130 and pull a grouping of team members based upon their skill 373.

One aspect is that IVI 399 does not simply collect people with a skill, but IVI 399 collects a group of people to fulfill the assignment 370, wherein that group is optimized to work together as a team. For example, we may need someone who is the focused back end worker, we may need a taskmaster, we may need the optimist, we need a visionary, etc. For any given project, if we select ten visionaries, and ten taskmasters, but only one back end worker, the project would not be completed well, as the visionaries would compete on the vision and the taskmasters would each try to delegate to others to do the work. Instead, the group consists of the appropriate number of team members, at the appropriate work experience, and blends them together to generate a team with the necessary skills to complete the job most efficiently, regardless of whether this assignment 370 takes a single individual 368 a group 367 of employees or a company 369 wide effort.

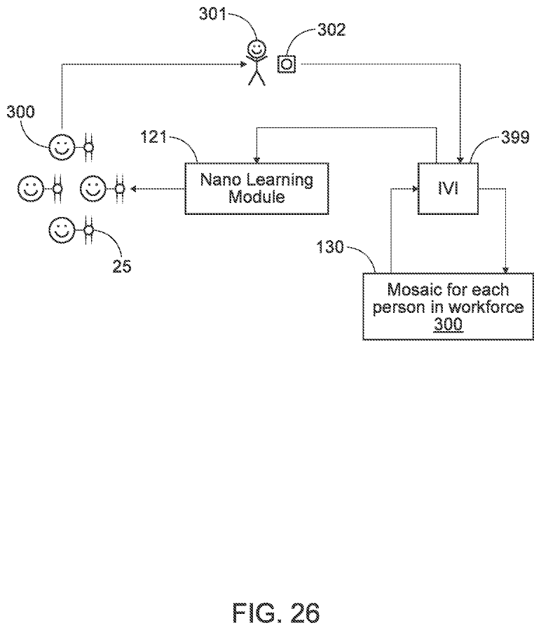

Deskless workforces, those who work in factories, on job sites, at warehouses, in trucks, etc., still have communication needs. Seamless communication is sorely lacking in these industries. Herein, embodiments detail methods of communication using reminders, whether to remind of a learning module, or of an SOP, of a task list, or the like, but use of reminders increases retention, efficiency, and ultimately value. Therefore, in certain embodiments, for example FIG. 26, further defines how IVI 399 can communicate with a mosaic 130 for each person within a workforce 300 to generate an appropriate response to a targeted issue. A group of members of the workforce 300 each have a mosaic 130 within a system, wherein at least one of the members of the workforce 300 has a wearable device 25 that can communicate with the members of the workforce 300. In addition to the wearable device 25, a smart phone or other mobile computing device can connect to one or more members of a workforce 300.

Thus, as in FIG. 26, as a customer 301 engages with a help button 302, the help button 302 generates a request to IVI 399 to identify a particular need. For example, the help button 302 may provide the ability to indicate a particular issue that the customer 301 is facing and this information can be relayed through IVI 399. Alternatively, the help button 302 can simply generate a request based on the location. For example, within a home goods store, a help button 302 can be located within a particular isle, where each isle has a particular set of goods that are sold. One aisle is hardware, one is lumber, one is paint, one is plumbing, etc. The help button 302 in each aisle would therefore indicate a different set of issues to be raised through IVI 399.

IVI 399 takes the issue raised, queries into the mosaic 130 for each of the workforce 300 members available and then sends to the workforce member 300 who can respond and provides an immediate nudge to the responding member detailing the issues. Thus, a nano learning module 121 is pushed to the worker's device that engages with and addresses certain issues to be raised and solutions to the same. For example, if the plumbing issue is raised, the nano learning module 121 might direct a set of questions to raise to help answer the question or might set a few simple reminders about issues typically faced for the specific plumbing issue. In this way, if the workforce member 300 is not an expert in plumbing, the answer to the customer 301 issue can still be resolved efficiently with increasing efficiency. If the answer is not easily identified, then another individual can be called in with the appropriate expertise to solve the issue.

Indeed, this nano learning module 121 can go a further step, as the help button 302 can take in not only issues with the question raised but may also take in visual or audio cues. For example, the customer 301 may be speaking in a raised tone, or frustrated tone, indicating some failure that needs to be addressed. Accordingly, a nano learning module 121 may simply be a reminder pushed to the member with a set of pointers to address the customer who may need to be calmed before addressing the issue. A nano learning module 121 of simple pointers for the workforce member 300 to address with the customer 301 or possible solutions (i.e., “I can comp something, I can give you a discount, I am a manager, I am a supervisor, I can send someone to your home to assist,” etc.) can be quickly identified in the nano learning module 121 to help appease the customer 301 and to solve the issue. The goal is to solve issues and retain customers by providing better service and tailored service.

Indeed, IVI 399 is utilized to take the input from the help button 302 and to use neural learning (AI) to generate an appropriate workforce member 300 and appropriate response to deal with the issue being raised, whether that is a specific expertise, or simply frustration that needs to be met with a person who better handles customers with heightened emotions. Through machine learning, we can generate better responses to better assist customers leading to better resolutions and customer service.

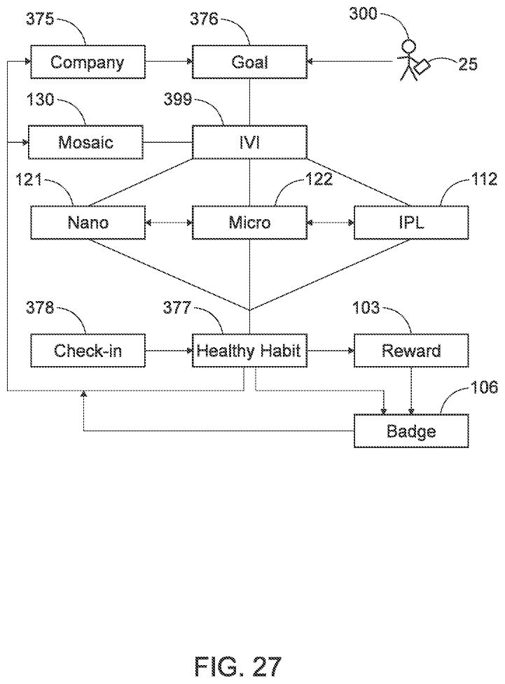

FIG. 27 builds upon this concept that we can optimize a workplace, not necessarily in response to a customer, as in FIG. 26, but with regard to optimizing habits within the workplace. Studies have shown that generating healthy habits, including proper diet and exercise, leads to improved quality of life and greater productivity. However, it is difficult to incentivize employees 300 to take these actions to a better lifestyle in many cases.

FIG. 27 details that an employee 300 with a wearable device 25 (or a handheld computing device, etc.) is a member of a workforce of a company 375. The company 375 has a targeted health goal 376 that is to achieve improved lifestyle choices, e.g. healthy habits 377. The goal 376 utilizes IVI 399 to communicate with a mosaic 130 (database of the employee's 300 person, goals, experiences, etc.) to identify strategies to promote the healthy habit 377. Different learning modules such as a nano 121, a micro 122, or a macro 112 (or in-person learning) are recommended from the IVI 399 (machine learning/AI). These learning sessions, individually, or as a composite over many learning sessions teach and gently drive home the healthy habit 377 that would meet the goal 376 of the company 375. Accordingly, the goal is analogous to a learning some data, and the reminders serve as reinforcement of the learning, namely to change a habit or remember to do some action, leading to a better result.

For example, the goal 376 is to have all employees exercise at least once a week. The goal 376 is once-a-week, and the healthy habit 377 itself is improved health of the employee 300. We can utilize the wearable device 25 to allow the employee 300 to check-in 378 at one or more exercise facilities, or with a machine itself. For example, the check-in 378 may simply be an RFID on an exercise machine at the company 375 gym or is connected to the heart rate monitor on the wearable device 25, with an increased heart rate meeting the threshold for the stated goal 376. Alternatively, the check-in 378 can be a RFID or other tagging system at a gym at the company 375 or at any number of external locations, or can be tied to another fitness application that tracks mileage or distance run, biked, swam, etc. Thus, we can tie the goal to a location or a time and use various connectivity devices (such as RFID) or others as disclosed herein for short or long range location based determination, to push the reminder to the user.

After completion of the healthy habit 377, the employee 300 is provided with a reward 103 and this reward 103 and the action completed can be recorded as a badge 106, and this in-turn is recorded on the mosaic 130. Accordingly, we can quantify and determine over time the healthy habits 377 of each participant and, as a company 375, we can track the advancement of the goal 376. This badge becomes the record of the completion of the action. Accordingly, in certain embodiments, the badge is simply a data entry for performing an SOP or meeting a task, in others, such as this healthy habit 377, it can serve as both a data record within a database, but also have some public accessibility and accountability, similar to a trophy, to show success.

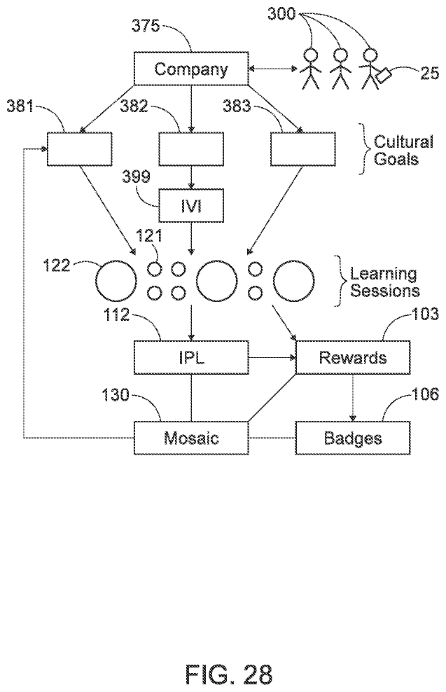

Of course, the healthy habit 377 can be something besides exercise. For example, it may be to stand every hour, to sit with better posture, to eat a healthy meal, or some other goal 376 that the company 375 feels is important to its overall habits. Indeed, this leads to the concept of FIG. 28 that a company 375 can indicate and plan for culture and find ways to manufacture culture within the employees 300 of the workplace. For example, an employee 300 with a wearable device 25 (or wireless device), participates in activities for company 375. Company 375 has set one or more cultural goals 381, 382, and 383 for the upcoming month/quarter/year, etc. We can utilize IVI 399 to take the cultural goals 381, 382, and/or 383 and define certain nano 121 and micro 122 learning sessions that can lead to an in-person 112 or macro learning session to generate modifications in culture. As with FIG. 27 before, that cultural goal may be to create healthy habits, and reward certain behaviors that benefit both the company and the individual, or some other goal. By rewarding these habits, larger portions of the company engage in such behaviors and a feedback loop is created that generates additional positive changes for employees. Thus, in FIG. 28 we generate a reward 103 when there is completion of the learning sessions 121, 122, or 112, and we can generate badges 106 that correspond to these completions. All of this information is then stored within the mosaic 130 and we can then move back towards additional cultural goals, e.g. 381, 382, or 383 to complete more learning sessions 121, 122, or 112 to generate additional badges 106 and rewards 103.

Ultimately, the goal is that we reward positive behaviors that benefit either the individual 300 or the company 375 as whole. These goals, when viewed individually seem insignificant, but if we collect these goals company wide, cultural changes can be made where better habits are created that lead to global improvements among the workforce which leads to improvements in productivity and cultural health.

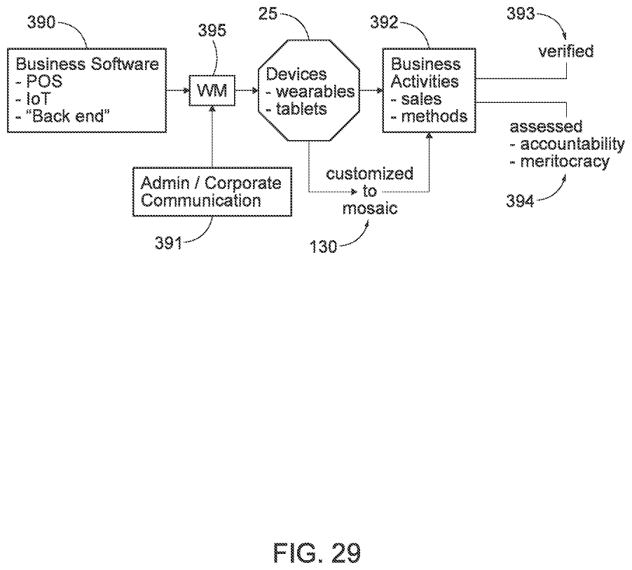

FIG. 29 details that we can also utilize these optimization goals within the point of sale (POS) systems used by most workplaces. We can combine the POS within the internet of things (“IOT”) (a grouping and network of the physical devices at a company) to identify needs within a business. For example, in FIG. 29, the business software 390 may include the POS system, IOT, and other backend software that can collectively utilize communication 391 from various administrative or corporate settings toward an AI box 395. We can then communicate what is being seen, heard, or needed through the software 390 and the corporate communication channels 391 to communicate directly with employees through wearable devices 25. We can customize actions and communication to these devices based on the mosaic 130 of the employee 300 as covered in prior figures. We can then utilize the customized information to lead toward improved business activities, for example to increase sales, customer services, etc. 392. Finally, these actions are verified 393 within a mosaic 130, for example by use of blockchain, and then there is an assessment that can be performed to evaluate employees. For example, “Did you perform the correct action when faced with an issue? Yes or No?” This is verified 393 by an assessment 394, and we can create accountability toward the employee 300 and use that to train the employee 300 and/or use it for meritocracy purposes. For example, one employee is simply better at converting leads into sales than others. Over time, we can recognize that the business software 390 and communication 391 remain consistent between employees, but one consistently generates more or better sales, and thus we can reward that employee. Similarly, we can review the various learning sessions and aspects on that user's mosaic to then find aspects that should be introduced, e.g. a cultural change to guide more employees to those same successes.

Accordingly, the embodiments herein seek to create methods for optimizing the individual and the workplace through the use of machine to machine learning and prioritizing and managing human process and capitol to enhance sales, customer service, etc. These are created through learning and reminder elements, namely the teaching of a data point (generically, anything being taught) and provided appropriate reminders to increase retention and/or uptake of the data point being taught. The various embodiments herein detail numerous examples of this practice.

For example, a restaurant has a goal of selling shrimp to customers. There are five managers at the restaurant, each having a wearable device (watch) on at all times for communication purposes. The restaurant assigns roles for transient workforce (those who are deskless, typically) and these team members get different wearable devices to engage with customers and optimize the operations. For example, the restaurant has a large salad business. Certain workforce members wear a blue watch to address and assist with the salad line. Another employee watches a screen (tablet or TV) to watch for any issues that are raised. This employee can communicate with any others to engage with customers who are in need of assistance. Thus communication is improved and response time towards customers is reduced.

Another employee can be a “floor hero” (green watch) whose job is to wipe tables and keep the premises clean and running for customers. As a customer enters, the green watch vibrates and a manager's watch vibrates, green identifies that table XYZ is dining in. The green watch is queued to communicate with the customers about specials and other aspects that may need immediate attention. In certain times, the customer has requests for food or beverages of other customers and using these devices we can allow for direct POS opportunities at the table. For example, someone has ordered a soup or appetizer that passes to another table. The customer asks, and we can quickly communicate that the soup was the daily special soup, or the appetizer was appetizer ABC, not DEF. We can direct this information at the touch of a button to engage the customer and drive the sale at the minute.

As indicated above, we can also utilize this in other operations. For example, a customer at a home goods store needs a plumbing part. Plumbing is on aisle eight, and we can identify that the customer is walking aisle eight but not finding the part. The customer can request assistance and identify that help is needed on aisle eight. In a typical scenario, the customer does not know if someone is coming to assist, nor do employees know if anyone is going to assist, and thus everyone else assumes someone else has given assistance. This is not optimized.

In the methods and systems of the present disclosure, when the customer hits the button to ask for assistance, we can query all employees working and identify that four people are listed as knowledgeable for the particular aisle, and each of the four are pinged and a response required. Employee E responds that he is busy. Employee F is on a break. Employee G, however, is free and inbound to assist. Employee G is knowledgeable about the aisle but can communicate with IVI 399 to help support the customer.

Ultimately, the methods and systems herein allow for capture of data and information from all sources. This allows us to utilize AI to predict behavior and to assist with customers in a highly optimized fashion to improve sales and improve customer service.

FIG. 8 outlines a flow-chart that outlines additional steps and features that can be utilized in methods and systems of the present disclosure. Specifically, FIG. 8 addresses a simplified process of identifying a learning type to deploy to a user. Beginning at the top, assessments 221 are performed, whether this is an exam, or an on-the-job event, or some other element where data can be collected 222. Once data is collected 222, a baseline can be set to make a comparison to a future event. The assessment and user is then monitored 223, namely is there a requirement or need to give a learning module? The nano learning deployer 224 determines, typically through AI, that a learning session is needed as learning session is pushed to a user either a visual 214, an auditory 213, or a detailed 212 message (e.g. a list, an SOP, and the like). This basic module can be repeated constantly, as assessments 221 can be found in everyday aspects of on-the-job performance, where data is collected 222 (and typically stored in a database), before deploying one of the learning modules to improve performance.

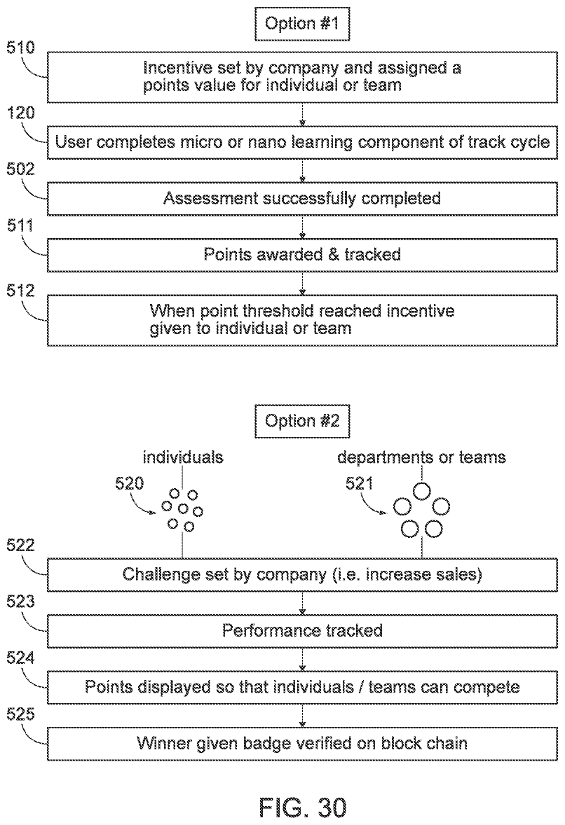

FIG. 30 outlines a specific inventive opportunity for a company in additional detail. For example, if a company wants to set a new goal to increase sales or to increase fitness, FIG. 30 could provide an example of that concept. For example, an incentive is set by a company and assigned a point value for an individual or a team 510. In certain above examples, the point value for each of the various examples was 1, 3, 5, 10, 15, etc., and then further comprised a modifier based on the individual company. Once a user completes a micro 122 or nano 121 learning session of a track cycle 120, points can be awarded. Assessments can be given 107, e.g. as in FIG. 1 and the assessment is successfully completed 502. We award points 511 to the user and these are tracked through blockchain.

In certain embodiments, we focus on the incentive being set toward a company, toward a group within a company, or toward an individual, where achieving a set incentive releases a reward. By tracking the points awarded and tracked 511, we can determine when a threshold is reached 512 and once it is reached, we can reward the individual, team, or company for meeting the threshold.

In a further aspect of FIG. 30, in “Option 2” a group of individuals 520 or departments or teams 521 seek a challenge set by the company 522, for example to raise sales to a predetermined number. Performance can be tracked 523, and points are displayed so that individuals/teams can compete 524 against one another. We can then reward the winning individual or teams a badge verified on blockchain 525. Accordingly, we create a gamification of the workplace environment to motivate individuals, teams, groups, or the company as a whole to reach toward a goal. Thus, aspects of learning a data point, or performance with regard to a goal can be augmented by the inclusion of gamification. Thus, reminders that are pushed to users on devices become a positive reinforcement or element because they lead to rewards for the users.

In certain embodiments, the data collected by the user becomes an asset to the user. For example, in certain embodiments, the user owns the data for their actions within blockchain or other encrypted data. The user can then utilize this data as an asset and sell or lease the data back to the employer. As an employer, for example, it is important for the employer to know the Myers-Briggs (personality test) type of its employees and such information can then be utilized if the employer wants to reward someone for offering that information. Simply put, data has value and in certain embodiments, the employee or user can monetize the data generated through her work.

As an entity, this would allow the company to understand the underlying culture and we can then incentivize certain actions that the company feels will improve the culture of the company. For example, it is valuable to have employees socialize and eat lunch together, but our company does not use the company cafeteria, such information would identify a disconnect or weakness in the model. We can modify the actions of employees and incentivize this action and then review, in real-time, the changes that occur based on the actions of the employees to remedy the issue and to guide change.

Obviously, for companies, certain changes are harder than others, but in this way we can both incentivize behaviors, reward those behaviors, and track them to allow for quantification over time.

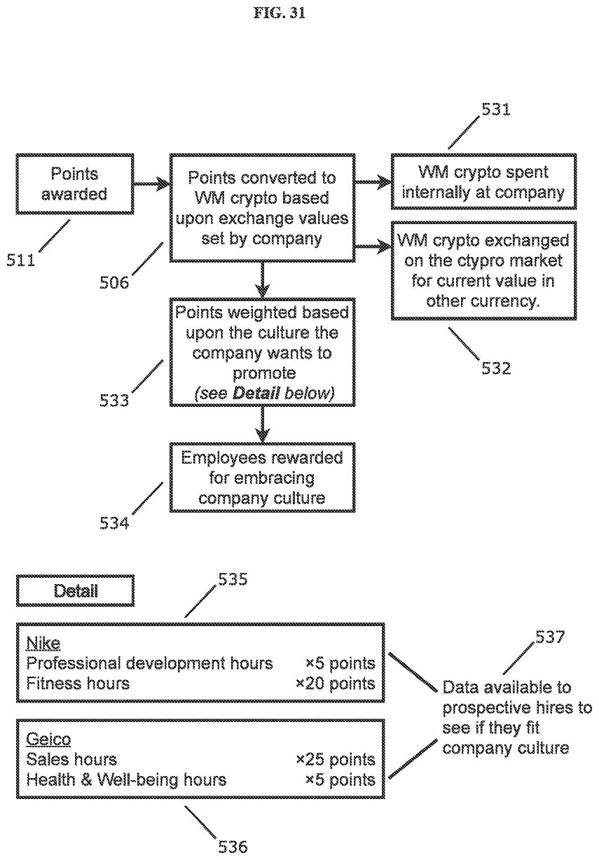

FIG. 31, provides detail of a function of the rewards system, wherein a user can evaluate businesses based upon the culture and actions of that user with regard to the user's own actions. For example, when points are awarded 511, the points themselves can be converted to WM crypto based upon an exchange value set by the company 506 (WM). We can then spend this money internally at WM 531 or we can exchange the WM crypto for open exchange for value in other currencies 532. The points themselves are weighted based upon the culture the company wants to promote 533. Ultimately, employees are rewarded for embracing culture 534 of the company. The detail in FIG. 31 further highlights an example of two companies, as with the example above. Here, the companies are Nike and Geico. Nike 535 weighs professional development hours at 5 points and fitness hours at 20 points. Geico 536 weighs sales hours at 25 points and health and well-being at 5 points. Someone focused on health or fitness would get more points from Nike 535 than from Geico 536. We can make this data available to prospective hires to see if they will fit company culture 537. Then, as with our examples for ABC and DEF above, we can add multipliers where we want to further reward points, or to give greater value for one particular aspect over another.

Ultimately, the user generates data that lives in blockchain. The user can mine this information to determine his or her actions for the year. However, this information may be valuable to the company and to advertisers alike. Ownership of this data becomes an asset. This allows an individual to take their actions, i.e. from their blockchain, and run them with N number of companies to find the fit they most desire. One might say that they would get paid more at another company as compared to their current employer. The user can then choose to leave or can utilize this to negotiate with their current employer for added benefits. A benefit to the user is that by using their blockchain data, the simulation will be accurate to what actually did occur, and not to partial memory of the actions performed. This gives a realistic and verifiable view of opportunities that may be missed by the individual user.

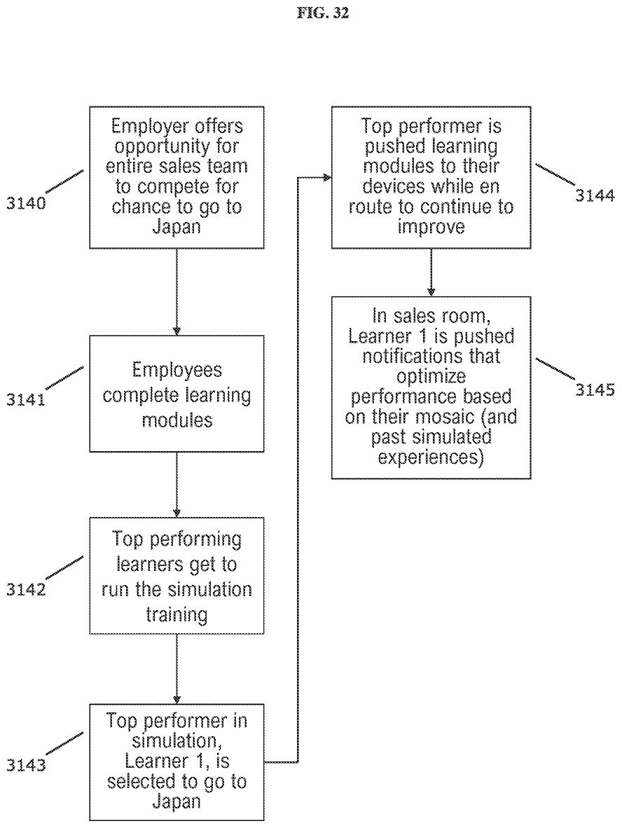

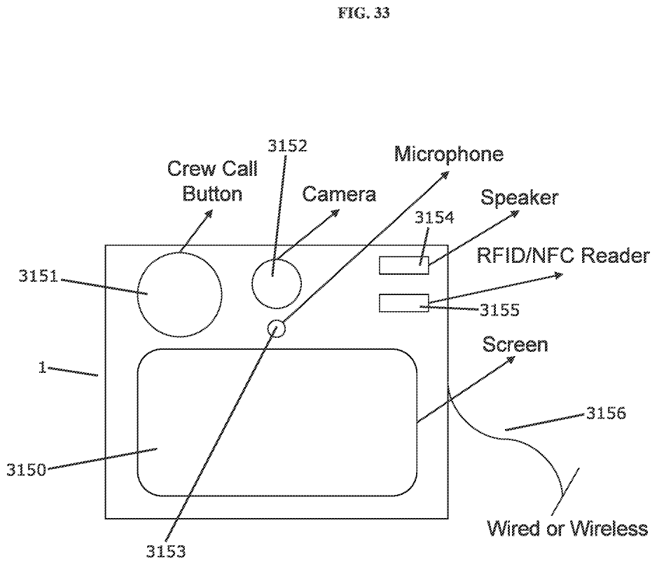

FIG. 32 is a flowchart depicting how a simulation can replicate real-world situations in practice situations. Simulation bends the curve to learn and do at the same time in a controlled environment. For example, Learner 1 is set to go to Japan to make a sale 3140. Simulation paired with the track cycle is a great way to prepare to make this sale in a different culture. Even with the training, though, how can Learner 1 receive real-time cues, customized to their personality and competencies, to ensure that the learning makes it all the way to the sales room? The solution is this system of simulated training 3142 paired with learning modules 3141, a mosaic, and a notification push system to wearable devices 3145. The example is as follows: There is an opportunity to go to a very high-profile sales meeting in Japan where there is a large commission potential. The employer offers the opportunity to anyone who wants to prove themselves 3140. Many people sign up for Japan sales learning and simulation track. Many go through the learning with their performance being recorded on their mosaics all along the way 3141. The employer then selects the highest performing group to perform under simulation and apply all that they've learned about the cultural differences, specific client needs, etc. 3142. For example, only people with 90% proficiency can go 3143. In the simulation event, they run the simulation 10 times and select the highest performer to go. In Japan, the watch sends Learner 1 receives nano modules based on their weakest knowledge base 3144. In the meeting, they are pushed reminders to be culturally sensitive since Learner 1 performed worst in their track cycle and simulation 3145.

FIG. 33 shows detail on various sensors needed for a particular embodiment 1. For example, the camera 3152 could be a single camera, or it could be a dual camera that is capable of measuring distance. This would allow a new data set to be streaming in from every crew call 3156. There is a microphone to send audio back 3153. There is a speaker to transmit sound 3154. In some cases, a screen 3150 will be useful to demonstrate something, or to create a virtual face-to-face conversation. There is a button to initiate the call 3151. There may be a version that has two or more buttons, each with a specific signal. For example, in a meeting space, one button might signal that there is an IT problem, a second button might signal food and beverage (and thus signal the kitchen staff and not the IT staff as in the first button's case) etc. In some models, there will be RFID/NFC reader for check-ins 3155.

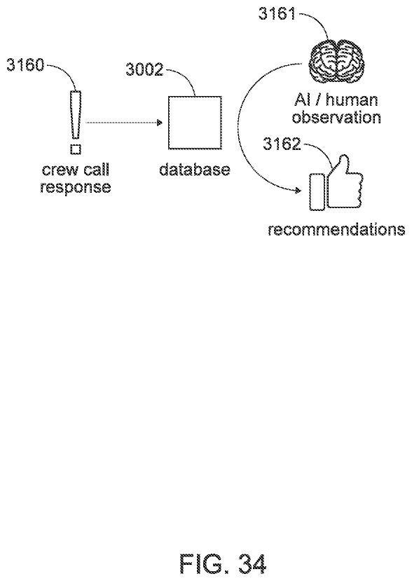

FIG. 34 depicts a flowchart of data. Data of requests and responses in terms of frequency, quality, timing of day, etc., can be used to generate recommendations of learning tracks for support staff and for quality assurance for learning products, enhancements to business processes, and rewards to individuals or groups. For example, a customer in a hardware store triggers a crew call to which a sales associate responds 3160. The response time and outcome are stored and tracked in the database 3002. The data is analyzed using both AI as well as human input from managers and customer satisfaction surveys 3161. Based upon the data, recommendations are made on how to improve performance 3162.

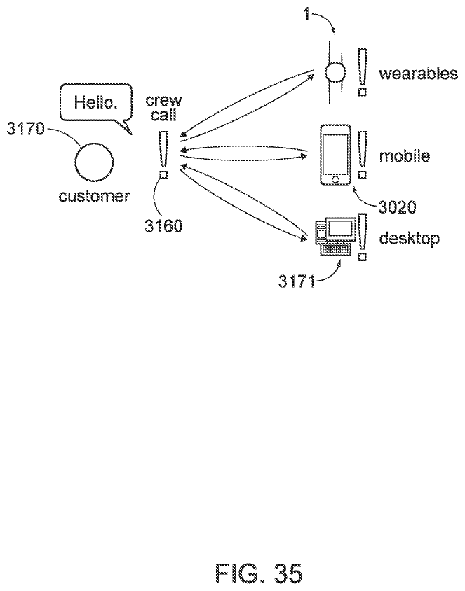

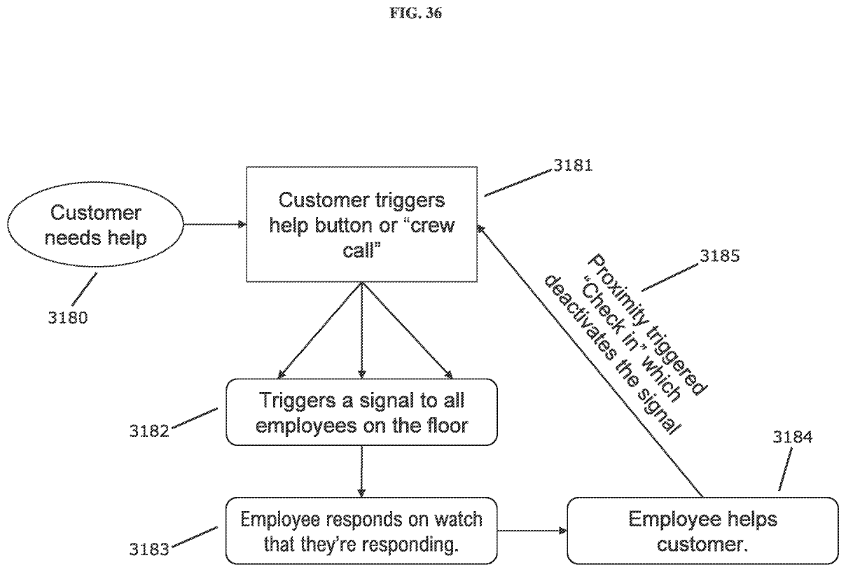

FIG. 35 depicts a flowchart of how a crew call requests triggers many devices and how those devices can be used to respond in various ways. For example, a client is hosting their meeting in a rented space that is utilizing the Crew Call 3170. The projector isn't working so a user triggers a crew call 3160. All the staff in the building connected to that signal will have, for example, their watches 1 buzz, their phones 3020 vibrate, and/or a notification pops up on their laptops 3171. The staff can voice communicate to the user that they will be in the room to fix the projector in less than 30 seconds. The employee shows up fixes the problem and the meeting proceeds. The customer has their problem solved without ever having to leave the meeting. Referring back to FIG. 34, the data collected 3002 on these interactions can be used to suggest that the amount of projector issues this month is 30% higher than last month 3161 and recommend a local service provider to check in on the issue 3162. This may result in an affiliate or referral kickback.

FIG. 36 depicts how crew call can help a customer receive support quickly from a staff member. In a store where a customer needs help in aisle 4 3180, for example, they could press the crew call 3181 which then sends out a signal to all the staff not on break 3 182. If no one responds within 20 seconds, then the staff on break will be notified. The staff members can respond on their watch, for example, by selecting, “I will respond,” or, “Unable to respond,” (in the case where they are already helping someone, etc.). This data of responses can be tracked on an individual basis. This data can then be used to generate training recommendations to increase customer service or can be a generator for rewards: “Eric responded within 5 seconds of 90% of the crew calls this week. Here is a reward.”

As a further example, a customer named Abby needs help, as she cannot locate the price on the product which wants to purchase 3180. Abby then triggers the help button or “crew call” to get assistance from an employee 3181. The button triggers a signal to all employees on the floor indicating a customer needs help in aisle 4 3182. Eric responds on his wearable or mobile device that he is responding to the help call and is on his way. Eric who is working on the floor, in that department, gets a notification on his wearable or mobile device that a customer in Aisle 4 needs assistance. Eric places his device in close proximity to the check-in station which deactivates the signal 3185 and acknowledges he is helping Abby 3184. The data point collected by check-in device 10 is then recorded using blockchain or a similar mechanism for securely storing and verifying data. With this collected data, it is possible to, as an employer or as a consultant, to calculate the average time it takes for employees to respond to help calls, or any other meaningful data. This can help reduce customer waiting time and increase customer satisfaction and increase brand loyalty and sales. This data can also be used to help identify and recommend employee training relating to customer service and satisfaction, or other relevant learning tracks.

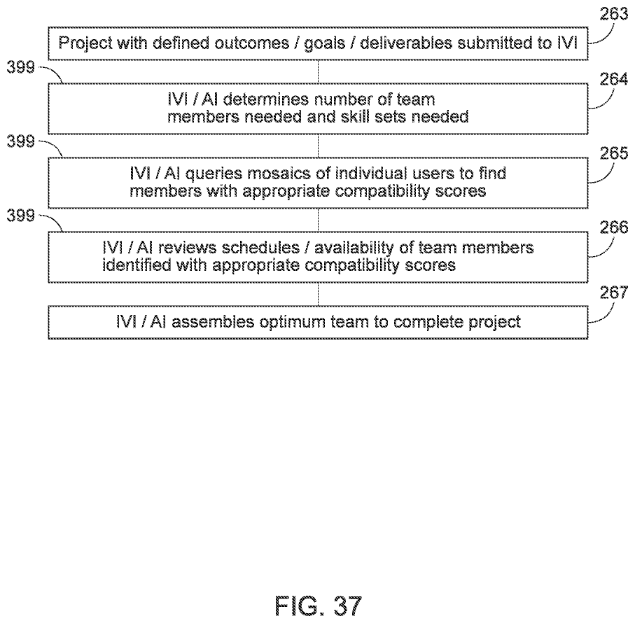

Turning to FIG. 37, as depicted is a flowchart of the AI process to identify a best fit, based upon the compatibility analysis. Beginning at the top, a project 263 with defined outcomes, goals, deliverables is submitted to IVI 399. IVI 399 reviews the project scope and the staffing needs and determines an optimal team size and skills 264 needed to most efficiently finish the project. IVI 399 then queries the mosaics 130 of individual users 300 within the company to find appropriate members to fill out this team 265.

This provides a list of preferred team members having the particular skill set and compatibility to meet the needs of the defined project 263. IVI 399 takes this list of team members and reviews schedules 266 to generate an optimum team 267 to complete the work. Accordingly, through use of the compatibility score 261, a team can be assembled to work on a defined project with defined outcomes, goals, and deliverables 263 to meet these needs within a defined time period.

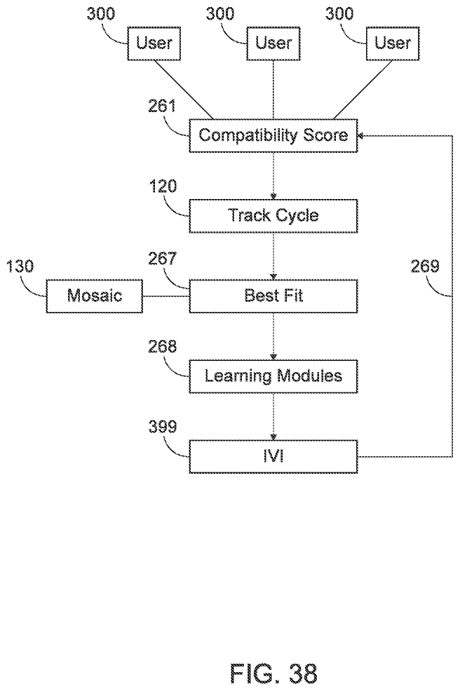

FIG. 38 further defines that we can utilize learning modules 268, including the nano, micro, macro, and other forms of learning to further optimize a compatibility score 261 of either an individual 300 or of a team. FIG. 38 details three users 300, each having a compatibility score 261. This compatibility score 261 fits within the track cycle 120 of FIG. 1, to continue learning modules for each of the users 300. As with FIG. 26, where a problem is generated, a best fit 267 of team users 300 to solve the problem can be generated. To do this IVI 399 reviews the mosaics 130 of a plurality of users 300. This process continues to cycle 269 until the optimal group is assembled.

However, we can modify and adapt the compatibility score 261 in real-time. For example, certain members have a lower compatibility score because they might not have completed some specific training that is likely to be useful for completion of a project. For example, a project might be to bake cookies for a fundraiser for a client. Several users 300 love to bake, but they don't have a favorite cookie recipe, or they are missing some aspect of cookie making that is deemed important by IVI 399. Instead of omitting these potential good fits, e.g. because they have high compatibility scores 261 except for the omission of this one knowledge. We can use the track cycle 120 to modify a learning module 268 to quickly provide training to these users 300. For example, a set of nano or micro training sessions might quickly show how to turn on the oven, mix the batter, form a cookie in a specific shape, etc. Because these can be done quickly, the mosaic 130 can be updated within minutes, and we can revise 269 the compatibility score to re-assess the potential users 300 available.

Accordingly, FIG. 38 details that omission of certain knowledge-based skills can be remedied through use of the track cycle 120 from FIG. 1 and learning modules 268 to bridge that knowledge gap.

Indeed, compatibility score 261 is more than just the specific knowledge, it is the combination of characteristics within the team that optimize the team to function best.

IVI 399 optimizes each set of characteristics needed based on the particular task at hand. For example, different personalities would be needed to bake cookies in a private kitchen, as in the example directly above, as compared to a sales blitz for a new client product, that would require dozens of cold calls to clients.

In certain embodiments, described herein, methods include first identifying a learning type. For example, IoT or systems can review and collect data by watching people interact with different content, and we can see how interactions are occurring. What is produced out of the interaction, is an understanding (intelligence) which is contextualized information, that shows that the individual user has a particular profile. For example, a visual, a detail, action learner. The intelligence is being deposited into a profile for the individual. As the intelligence learns what content is preferred, the content can be adapted in real-time and continue to learn/train a machine learning to provide better content.

For example, we have an apple: One learner type wants to see an image of an apple, a second type, we spell out the word and describe the fruit, and for another, we hand them an apple. Once a user has interacted with the apple, we can identify how they interacted with the apple and then we can make a recommendation downstream.

However, just because a user prefers one learning type, it is valuable to be adaptable. It is valuable to be able to experience different learning opportunities and to still thrive, as real-world applications will not be perfect towards a user's individual type of learning. Accordingly, machine learning needs to identify what types of learning a user should receive, beyond just the preferred learning type.

Simultaneously, as learning is occurring, the machine learning is tracking the experience, the knowledge learned and then making recommendations for what should be presented to optimize learning as a whole. Again, if someone is a visual learner, we may focus on the visual aspect, but that does not mean that detail or hands-on learning is not critical to give a complete understanding of the issue. However, learning will predominantly be targeted based upon strengths of the user.

As learning progresses, the machine learning can then help to identify a subsequent learning module. For example, above, we learned about an apple, and now we need to learn more about what we can do with the apple. Additional modules might include how to eat the apple, i.e. take a bite, cut it, cook it. However, it may be necessary to then also teach someone how to cut an apple and to core out the seeds. For the purposes of cooking an apple, we might need to teach how to turn on an over, or how to bake an apple pie. As you can see, the single concept of an apple can then allow that concept to lead down into many educational opportunities that are only partially related to the original concept, but that drive a wide set of knowledge.

In a corporate setting, we can utilize this concept among an individual, or among teams, to help the individual and the group thrive to ensure that the individual and the team have the necessary education or knowledge, and also the training to be most effective as one and then as a whole.

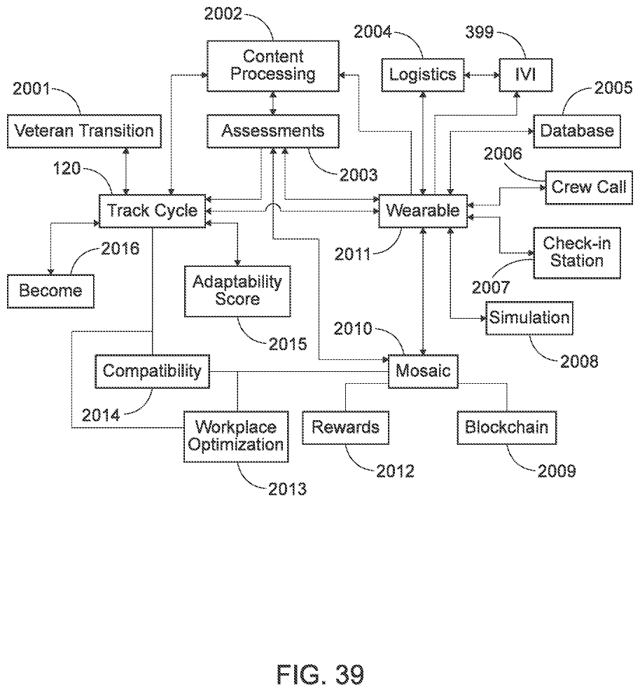

Finally, FIG. 39 details the interoperability of the various embodiments and how they work together to create unique methods and opportunities for workplace optimization. Wearables 2011 are central to the embodiments, as wearables both capture data and also display or proj ect information to a user. The wearable 2011, as described above, interacts with educational opportunities through the track cycle 120. The track cycle, in combination with the mosaic 2010, can generate an adaptability score 2015, as well as be utilized to develop certain educational plans through become 2016. Ultimately, the learning is important and the mosaic 2010 important of defining compatibility scores 2014, and workplace optimization 2013, that are generated through understanding the various elements of a mosaic 2010 and how teams and individuals can maximize their talents. The mosaic 2010 also adds in elements such as the rewards 2012, and the mosaic 2010 is secured through the use of blockchain 2009.

The wearable 2011 and the track cycle 120 also function through various assessments 2003, and these assessments and the education are essential when considering IVI 399 and the ultimate impact on the mosaic 2010. Once educational plans are determined, certain content processing 2002 must occur to take raw content and generate the content for the track cycle 120 and to prepare and display the content on the wearable 2011.

In other embodiments, IVI 399 can take on larger roles, outside of the machine learning/AI module, and perform those features while also comprising certain sensors. For example, IVI 399 can transition as a robot and be useful for sales and marketing, but also for logistics 2004.

The wearable 2011 specifically functions with databases 2005, as well as with a check-in station 2007. Wearables also communicate via various embodiments of the crew-call 2006. In each instance, the wearable 2011 is a key feature that is used to identify issues, communicate with a team, receive instructions from team members, and to solve consumer issues.

Finally, simulations 2008 are necessary to practice and perfect the various elements that are described herein. We can utilize a wearable 2011 to track users during a simulation 2008 and to help with post simulation feedback. In certain embodiments, veteran transition 2001 can also be aided in these concepts, namely of developing education and strategies to enhance the chance of success of veterans. And that transitions cleanly to the concept that we should develop strategies to increase efficiency for all users.

In sum, the wearable 2011 is a central focus and its use provides for unique applications for delivery of content, transmission of data, and for improving workplace efficiency.

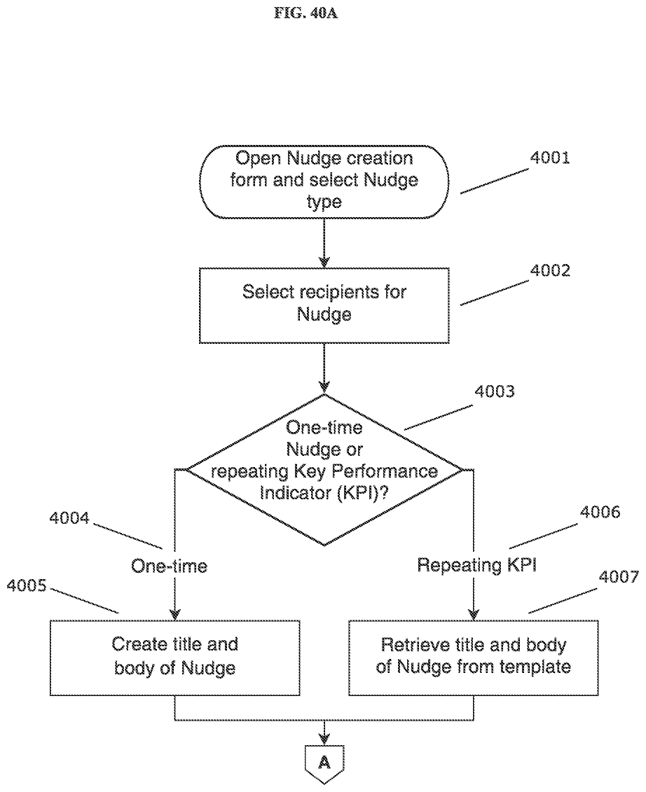

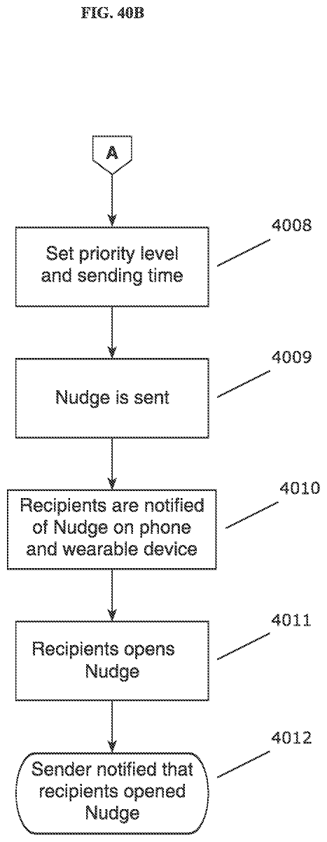

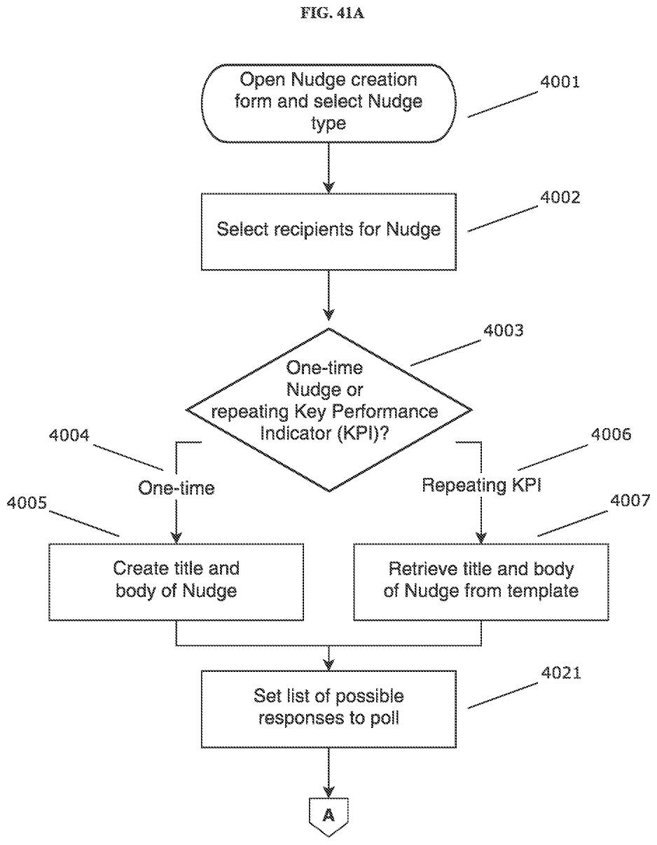

Turning to FIGS. 40A and 40B, the element of providing a reminder provides a significant boost to an individual in achieving mastery of the element being reminded. For example, when learning a new skill, if the person only learns once and then leaves, the skill or information is easily lost. If, instead after the initial learning, reminders are provided, the skill or information has a much greater chance of being retained.

The reminder itself can come in several different forms, as disclosed in the various specific embodiments herein. In certain embodiments, a reminder is called a “nudge,” and the nudge can come in several different forms. The nudge itself typically includes a type of nudge, the recipient, a title, and content, and such information can be captured and saved into a database. The nudge can be a one-way 4004 or a two-way. Basically, one-way does not require or expect a response, while the two-way nudges have an expected response. A one way might be simply a reminder, a list, an SOP, an image, etc., to provide instantaneous information to help a user find success.

Two-way nudges however can be a poll nudge or a feedback nudge. For example, a poll nudge might simply respond with, “Got it,” to a message, a Boolean response (Yes/No or other binary response), or multiple response options. Such poll nudges allow for information to be shared in two directions.

Feedback nudges provide similar features to a poll nudge but include subjective text responses. This would allow for additional material to be provided beyond a simply binary response or multiple choice response. In preferred embodiments, a user can use speak-to-text dictation to quickly provide a response and narrative to the responsive nudge.

As provided in the various embodiments, these nudges can be triggered directly from another user, scheduled at a time or location, triggered by the occurrence of a time or location and the device, by IoT devices or systems that generate data, e.g. SCADA and the like. Thus, a user engages an app on a device, provides the information to send the nudge to a user, and sends the nudge. If the nudge is scheduled or triggered, it is stored and occurs when the condition precedent is triggered.

A type of nudge might be a smart task. Such smart task can be generated through a form that may include one or more of a task title, a task description, a task category, priorities, an assigned person or location, a beacon sensor proximity or geofence proximity condition, and a status (open or complete). Thus, a smart task is one that is generated upon the proximity or entry into a location field. This is critically important for many jobs as the nudge is most effective when provided at a given location and when the user is actually at that location. Furthermore, the ability to actually execute a task is determined only when the user is within the distance of the proximity sensor or within the geofence proximity condition. Thus, the user will have a graphical user interface (GUI) comprising a task item with a task description. And the task item can be viewed under all conditions, but it can only be completed when within the proximity sensor condition or within the geofence. Thus, a user can complete a task, and if within either proximity condition, mark the task complete. If the user is not within that proximity condition, then the item cannot be completed. This ensures proximity and contemporaneous completion of tasks.

For example, if a patient at a hospital needs to take medication every 6 hours, this method can be useful to ensure compliance. A task nudge can appear based on the necessary time and remind a caregiver to give the medication. Upon entry to the proximity condition, the task status is engaged and, the user can provide the medication and then actually mark the task as completed so long as the proximity condition remains met.

Smart locations use a similar feature as the smart task, namely a proximity or geofence location requirement. Thus, information is generated automatically based on meeting a proximity requirement, whether a geofence, a beacon, a radio, a wireless, WiFi, or other connectivity means. Thus, a beacon sensor can generate a card with information for a user when sensed by a beacon and a geofence can generate the same once within the geofence.

For example, those in the real estate business or a deskless worker who is trying to identify a property can be identified by the geofence. Property locations, for example, can be stored within a database and accessed via an application programming interface (API). This would allow a map to be generated within a GUI showing the locations. Upon reaching the threshold proximity set by the particular settings, certain information can be displayed or provided to the user. Thus, in the real estate example, the user might be a real estate agent who is showing a property. Upon proximity to the property, certain information, such as building access code, or particular details of the property are provided in a nudge to ensure that such information is fresh and available to be provided.

Such proximity can also be used to count and track users. Thus, if a person is required to check a patient every X hours, the proximity beacon can identify such occurrence and store said information within a database. An hourly worker who must track time can start hourly time only when in proximity of the device or the premises. Hourly workers can only track breaks or lunch when in another space, etc. Thus, a worker might only be able to clock in or clock out based on a particular location to maintain confidence and accuracy in the timekeeping books. There are numerous other industries that track time, track attendance, and this provides a greater level of accountability to the user to prove their time, but also management to confirm the same.

Smart Notes allow for contemporaneous comments to be provided in a secure manner. A user can create a note that will track time and location, and provide space for other essential details within the user created note. The note then automatically captures the date, time, longitude and latitude and this information can then be exported to email, chat channels, text messages, or other client databases via an API. Thus, a user GUI can define the essential parameters and can be modified based on the needs of the consumer and user of said notes. Such information is vital where contemporaneous business records need to be maintained, and this can prove the time and location of the notes to ensure accuracy with regard to said business records.

A smart form is a variation of a note, but may include greater pre-populated fields in which to capture information. However, the smart form captures time, date, location, and allows for export to a database system via email, client server/database via an API. In particular embodiments, the form is generated so as to have a limited subset of expected responses. For example, a health form might have several fields that include a medical record number, name, date, issues, and then fields for height, weight, age. We can utilize AI to then identify that each answer has a predicted response, and the responses can be auto filled into the appropriate spaces, e.g. through speaking to the form. If the form requires (1) height, (2) weight, (3) blood pressure, (4) temperature, and a care giver speaks to the form and says “73 inches”; “197 pounds”, “120 over 80” and “98.8” the form will recognize that the responses for 73 inches goes to height, that 197 pounds goes to weight, and 120 over 80 goes to blood pressure, and that 98.8 goes to temperature. These can find the correct location regardless of their order, as we can train the AI to recognize an expected value. As a first value is given, the AI can best fit the response into a category, i.e. it has to choose one of four locations. As a second value is given, the second can now be added to the data set and each is best fit into the proper location and is repeated after each data point is given. Thus, while one data point might have risk of improper placement, re-calculating the proper fit after receipt of each data point can improve the best fit of the data to a form.

Further notes may involve a feature that is similar to text messages. Text messaging is ubiquitous on numerous platforms but suffers from exchange of personal and professional information in a single location. Thus, texting can exist in a platform-based system that does not require an individual to provide a personal cell-phone number to another worker. This allows each employee or user to have a unique ID, and to share text, data, images, videos, etc., as would exist on other platforms. However, the platform is stored and databased to allow for quality control. This allows for reliable messaging without the need to exchange personal information.

The entire system and platform is based at the highest level of learning and then providing a reminder of the original learned element to increase learning. Thus, to Learn Smart, is to learn through such a methodology. Within a GUI, a user can access certain learning modules via a learning management system (LMS). These modules may be training someone new material, providing task based reminders, providing overview materials to solve issues and the like. The GUI can interface, via API, with LMS systems to exchange material as needed.

The learn smart platform includes pre-learning, where concepts may be introduced. Thus, certain information can be provided to a user as introductory material, and the user can access the GUI to engage with poll nudges and other nudges to test and account for the learning, as the poll nudge can ask binary or other questions and require or expect a response to the same. Furthermore, the GUI can share text, video, or oral messages and again track success for individuals and for groups as a whole as to how to best learn an element.

Post learning follows with nudges to improve knowledge retention through text reminders, SOPs, or even through assessments, such as a quiz which can be sent via a poll nudge. Additionally, post learning, feedback can be easily provided through use of this system. We can further track all the pre and post learning and track the results to the individual, to the group, to the company as a whole, etc.

FIGS. 40A and 40B define a flowchart of a nudge formation and elements that may be included within a nudge in any of the various embodiments described herein. In a GUI or App on a device, the nudge creation form can be opened 4001 and recipients selected 4002 from a list, or typed into a search bar, or manually added to a recipient list. The nudge type is identified 4003, either a one-time nudge or a repeating key performance indicator (KPI). If the nudge is a one-time 4004, then a title and body 4005 is generated manually. Similarly, if the nudge is a repeating KPI 4006, a title and body is formed from a template 4007. Turning to FIG. 40B, the priority level for the nudge 4008 is set allowing for a user to determine how the nudge will be viewed by the recipient. For example, no notification, priority, urgent, or other classification as determined by the administrator or sender. The nudge is sent 4009 and the recipient is notified of the nudge 4010 on an electronic device such as a phone or wearable device. The recipient can then open the nudge 4011 and the sender can be optionally notified that the recipient has opened the nudge 4012. This receipt is important in cases where a single user is notified and so a read receipt (i.e. 4012) would be desirable. But if 1000 nudges are sent (or some other large number), the read receipts might be overwhelming. It is possible to send a read receipt 4012 to the server/database without sending to the sender.

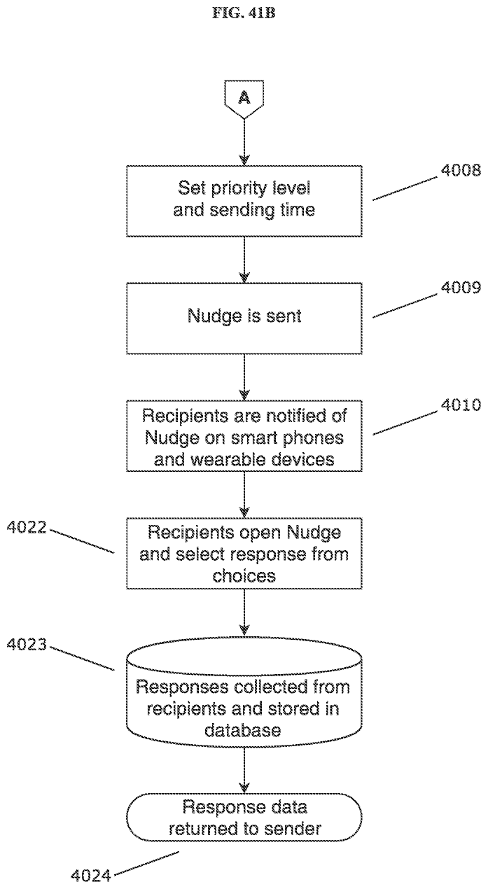

FIGS. 41A and 41B follow a similar nudge concept for poll nudges. Indeed, the nudge can be one of several different forms, namely something that is merely a reminder, educational, task creating, or others as disclosed herein. FIG. 41A begins with a nudge creation 4001, recipients selected 4002, selecting the nudge type 4003, either a one-time 4004, or a repeating KPI 4006, where the title and body are entered 4005 for a one-time 4004 or retrieved from a template 4007 in the KPI. Indeed, in KPI forms, a template is previously created in order to allow for ease of use and consistency with regard to the body, look, and feel of the nudge. In the case of a poll nudge, the sender can then identify a list of possible responses to the poll 4021. Turning to FIG. 41B, the priority level 4008 is selected and the nudge sent 4009. The recipients are notified of the nudge 4010 and the recipient upon opening selects a response to the nudge 4022. The responses are collected from the recipients and stored within a database 4023, and the response data can be collected and returned to the sender 4024 or held within the database for mining.

What is claimed is:

1. A method of increasing retention of data comprising:
a. identifying the data to be retained by a user;
b. providing the data to the user;
c. providing a reinforcement action to said user in the form of a notification on an electronic device; and
d. wherein providing said reinforcement action to said user increases retention of the data.

2. The method of claim 1, wherein the data is selected from the group consisting of a standard operating procedure (SOP); a task to complete; instructions; or facts.

3. The method of claim 1, further comprising at least a second reinforcement action; wherein said second reinforcement action is different than the original reinforcement action.

4. The method of claim 1, wherein the data is stored electronically within a server; and wherein the reinforcement is stored within said server.

5. The method of claim 1, wherein the reinforcement is provided upon the occurrence of a traceable event.

6. The method of claim 5, wherein the occurrence the traceable event is defined within a database.

7. The method of claim 5, wherein the reinforcement is provided upon the electronic device being placed within a predetermined proximity to a location.

8. The method of claim 7, wherein the location is defined by the group consisting of a geofence, a WiFi signal, an RFID signal, a wireless signal, a radio signal, or a beacon.

9. The method of claim 1, wherein the reinforcement is provided at a predetermined time.

10. The method of claim 1, wherein the data to be retained is defined within an SOP, wherein an error in the SOP is defined as a traceable event, and wherein the reinforcement is provided upon the occurrence of the error in the SOP.

11. The method of claim 10, wherein the error in the SOP is remedied after receiving the reinforcement.

12. A system for increasing retention of data comprising a database and at least one electronic device capable of sending and receiving wireless notifications of information from said database, wherein a data point to be retained by a user is loaded onto said server; a notification is pushed to said user and received on said electronic device, said notification comprising material to reinforce the data.

13. The system of claim 12, wherein said electronic device is selected from the group consisting of a smartphone or a wearable electronic device.

14. The system of claim 12, wherein said electronic device comprises a mechanism to determine location; wherein the database provides for said notification to be pushed to said user upon entry to a particular location; and wherein said notification is pushed to said electronic device upon accessing said location.

15. The system of claim 12, wherein said electronic device and database comprises a time keeping mechanism, and wherein upon the occurrence of a predetermined time, a notification is pushed from said database to said electronic device.

16. The system of claim 12, wherein said material is selected from the group consisting of a video, SOP, facts, lists, tasks, or combinations thereof.

17. A system for creating time and location based records comprising: a database, and an electronic device, said electronic comprising a software application having a graphical user interphase for sending and receiving data from said database; said electronic device comprising a timing mechanism and a location defining mechanism; said graphical user interface defining at least one task to be completed; said graphical user interface having a binary feature for annotating the completion of said task, said binary feature capable of being annotated only upon meeting either a predetermined location or a predetermined time, wherein upon meeting said predetermined location or said predetermined time, said binary feature is authorized to allow annotation of the task.

18. The system of claim 17, wherein said graphical user interphase displays the requirements to allow the binary feature to be authorized.

19. The system of claim 17, wherein both the time and location must be simultaneously met to allow the binary feature to be authorized.

20. The system of claim 17, wherein upon the annotation of the task, the time and location of said annotation is recorded within said database.

21. The system of claim 17 wherein the task to be completed is displayed only upon meeting either the time or location criteria, wherein the task to be displayed is provided as a notification onto said electronic device.

22-64. (canceled)
